(19) United States
(12) Patent Application Publication
(10) Pub. No.: US 2024/0394815 A1
(43) Pub. Date: Nov. 28, 2024

(54) INTELLIGENT REAL ESTATE TRANSACTION SYSTEM WITH PERSONALIZED RECOMMENDATIONS BASED ON USER PREFERENCES AND INTENT

(71) Applicants: Sairamkumar Venkataraman, Los Altos, CA (US); Manimuthu Ayyannan, Fremont, CA (US)

(72) Inventors: Sairamkumar Venkataraman, Los Altos, CA (US); Manimuthu Ayyannan, Fremont, CA (US)

(73) Assignee: MYREALTYTECH INC., Los Altos, CA (US)

(21) Appl. No.: 18/674,178

(22) Filed: May 24, 2024

Related U.S. Application Data
(60) Provisional application No. 63/504,064, filed on May 24, 2023.

(51) Int. Cl. G06Q 50/16; G06Q 30/0204; G06Q 30/0241; G06Q 30/0251; G06Q 30/0601; G06Q 30/0645

(52) U.S. Cl. CPC G06Q 50/167; G06Q 30/0205; G06Q 30/0271; G06Q 30/0277; G06Q 30/0631; G06Q 30/0645

(57) ABSTRACT

An intelligent real estate transaction system and a method thereof with personalized recommendations for the buyers based on preferences and intent is illustrated herein. The system includes a continuously updated property database with property listings, a web based online transactional platform to facilitate transactions among sellers, realtors and buyers, a collaboration platform to share information and resources about a property and a personalized recommendation system to facilitate location and context-based targeting to sell/rent/lease the property. An AI based processing engine is made functional with the property database and at least one user module is implemented as an API server to process the communications between at least one user module and the property database. The transactional platform facilitates communication between the seller and the buyer. A machine learning algorithm (ML) is used to process and analyze the input data from the user to generate personalized recommendations.

### CROSS-REFERENCE TO RELATED APPLICATION

The present Non-Provisional patent application claims priority to the U.S. Provisional Patent Application bearing the Ser. No. 63/504,064, filed on May 24, 2023, entitled INTELLIGENT REAL ESTATE TRANSACTION SYSTEM WITH PERSONALIZED RECOMMENDATIONS BASED ON USER PREFERENCES AND INTENT, which is hereby incorporated by reference in its entirety for all purposes.

### BACKGROUND

The subject matter of the present invention disclosure and various embodiments described herein relate generally to real estate. Particularly and not exclusively, the subject matter of the present invention disclosure and the embodiments described herein relate to the personalized recommendation system for real estate transactions that is intentionally based on the preferences and intent of the user.

### SUMMARY

Current market has misaligned incentives with third parties and brokers cornering 4%˜6% of the transaction and sellers are not always optimizing the value of their property. Dominant brokers can charge a premium without delivering high quality services to sellers and buyers. Currently a seller engages third parties (a realtor) who typically charge 4%˜6% of the sale value and help the seller liquidate their property holdings.

The realtor will help the seller prepare a brochure, conduct an open house, organize bidding for their property and close the transaction. The buyers will often engage their own realtors who will help them bid on properties and close the transaction. Both the sellers and buyers' realtors do not always have perfectly aligned goals with the buyer and seller. One highly inefficient part of the current system is around how buyers place bids on properties they are interested in. It is usually a blind bidding system where buyers or their realtors place bids with the seller's realtor.

Accordingly, in order to overcome one or more drawbacks associated with the related art, there exists a long felt need for a personalized recommendation system for real estate transactions that is intentionally based on user preferences, which will be understood by studying the following description.

Few of the objects of the present invention disclosure are as follows.

The primary object of the present invention is to provide a personalized recommendation system for real estate transactions that is intentionally based on user preferences and intent.

An object of the present invention is to provide a personalized recommendation system for real estate transactions that is intentionally based on user preferences and intent which facilitates sellers to extract great value from their lifetime savings and minimize commissions paid to third parties.

Another object of the present invention is to provide a personalized recommendation system for real estate transactions that is intentionally based on user preferences and intent which ensures a better fit and higher quality investments in properties by prospective buyers by understanding their intent and providing targeted recommendations.

Yet another object of the present invention is to provide a personalized recommendation system for real estate transactions that is intentionally based on user preferences and intent which facilitates sellers to sell for more and buyers to make the right investments while minimizing the role of third parties who do not add value for the rates they charge.

An additional object of the present invention is to provide a personalized recommendation system for real estate transactions that is intentionally based on user preferences and intent which provides a bidding system that offers multiple types of bidding such as auctions, first across the post and the like, and further allows for the immediate creation of documentation to meet compliance requirements around bids, integration with SMS and popular messaging systems and easier approval mechanisms for owners.

Further object of the present invention is to provide a customizable system for real estate transactions that is intentionally based on user preferences and intent which can be run by realtors.

Furthermore object of the present invention is to provide a customizable personalized recommendation system for real estate transactions that is intentionally based on user preferences and intent which provides tools to enable and empower the seller and the buyer against the third parties.

An object of the present invention is to provide a customizable personalized recommendation system for real estate transactions that is intentionally based on user preferences and intent, the model of which is based on mathematical logic and algorithm to make the system efficient than a manual bidding system.

Another object of the present invention is to provide a customizable personalized recommendation system for real estate transactions that is intentionally based on user preferences and intent which facilitates transparency on the bidding system to buyers if the seller so chooses.

Yet another object of the present invention is to provide a customizable personalized recommendation system for real estate transactions that is intentionally based on user preferences and intent which provides an inspection report and summarized disclosure to facilitate savings of time for both the buyer and realtor.

An additional object of the present invention is to provide a customizable personalized recommendation system for real estate transactions that is intentionally based on user preferences and intent which provides an artificial intelligence (AI) driven conversational and interactive advisor and guide for the buyer and realtor, with a predictive intent model, a math-based bidding system, and automated inspection and disclosure summaries to aid the realtor in providing high-quality services to the seller and buyer.

Other objects, aspects, features and goals of the instant invention will be better understood from the following detailed description taken in conjunction with the accompanying drawings.

The plurality of systems, methods, platforms and devices described herein each have several aspects, no single one of which is solely responsible for its desirable attributes. Without limiting the scope of this disclosure, several non-limiting features will now be discussed briefly.

According to a primary aspect of the present invention, the intelligent real estate transaction system with personalized recommendations based on user preferences and intent includes a property database consisting essentially of information related to one or more property listings with the inclusion of properties for sale or properties for rent or properties for lease or a combination thereof. Each such property is provided with a unique and specific identifier (ID). The property database is updated continuously with block chain technology. The block chain technology is enabled to ensure secured and tamper-proof real estate transaction database to store the information related to the real estate transaction. There is a mechanism provided to manage the registration, login, authentication and authorization of a user in order to enable only authorized users to access the system.

There is a web based online transactional platform with an intelligent real estate transaction system which is adapted to facilitate collaboration among users to share the information and resources about a property included in the property listing and to further facilitate the location and context-based targeting to sell/rent/lease the property.

According to an additional aspect of the present invention, at least one user module implemented as an application programming interface (API) server is functionally coupled with the property database via a computer network to facilitate a user to access the property database via a user interface on a web page or a mobile Application on an electronic communication device. The user is either a buyer or a seller or a service provider. The user interface enables the user to input his preferences and intent and incorporate a wide range of data sources to the intelligent real estate transaction system, The system understands the context of the user's input and a machine learning algorithm is used to analyze the input data to generate recommendations wherein the recommendation is based on the continuously updated and analyzed property database to identify trends and patterns.

According to a further aspect of the present invention, the at least one user module is either an artificial intelligence (AI) realty advisor, or one set of tools and resources, or one matching module, or one machine learning (ML) based crawler module, one intent prediction module, or one crime score generator module, or one bidding module, or one property value optimization module, or one smart contract management module, or one real estate metaverse module, or one customer-generated content module, or one proactive customer engagement module, or one collaborative property listing sharing module, or one real estate value prediction module, or one seller/buyer matching engine, or one module with incorporation of a wide range of data sources and features, or one buyer insights platform, or one seller insights platform, or one AI realty rental platform, or one collaborative filtering-based recommendation module, or one group investment platform, or one encrypted negotiation portal.

The web based online transactional platform is adapted to facilitate the communication between the seller and the buyer over the computer network. The various platforms, portals and modules of the intelligent real estate transaction system are configured to display the information relating to the current status of buyer driven real estate transaction events via the user interface on a web page or a mobile Application on an electronic communication device.

The AI based processing is functional with the property database and at least one user module to process and analyze the inputs received and to further process and analyze the communications via the computer network between at least one user module and the property database to generate personalized recommendations on the property to the user.

According to an additional aspect of the present invention, a method for intelligent real estate transaction with personalized recommendations based on user preferences and intent is provided. The method includes the steps of: maintaining a property database on the intelligent real estate transaction system consisting essentially of information related to one or more property listings with the inclusion of properties for sale or properties for rent or properties for lease or a combination thereof; providing each property listed in the property database with a unique and specific identifier (ID); updating the property database continuously with block chain technology for secured and tamper-proof real estate transaction; storing the information related to the real estate transaction in the property database; providing a web based online transactional platform for facilitating collaboration among a plurality of users to share the information and resources about a property included in the property listing; facilitating further the location and context-based targeting to sell/rent/lease the property via the web based online transactional platform; coupling At least one user module implemented as an API server with the property database via a computer network for facilitating a user to access the property database via a user interface on a web page or a mobile Application on an electronic communication device; enabling the user to input his preferences and intent to the system via the user interface; incorporating a wide range of data sources to the system by the user; enabling the intelligent real estate transaction system to understand the context of the user's input; enabling the intelligent real estate transaction system to analyse the data input received from the user to generate recommendations based on the continuously updated and analysed property database to identify trends and patterns using a ML algorithm; and configuring the various platforms, portals and modules of the intelligent real estate transaction system for displaying information relating to the current status of buyer driven real estate transaction events on the user interface.

The following description is illustrative in nature and is not intended to be in any way limiting. In addition to the illustrative aspects, embodiments, and features of the instant invention, further aspects, embodiments, and features will become apparent by reference to the following detailed description.

### BRIEF DESCRIPTION OF THE ACCOMPANYING DRAWINGS

The non-limiting and non-exhaustive embodiments of the present invention are described with reference to the figures in the accompanying drawings wherein like reference letters and numerals indicate the corresponding parts in various figures unless otherwise specified. It will be appreciated that for simplicity and clarity of illustration, parts and elements illustrated in figures of the drawings have not necessarily been drawn to scale. Further, the accompanying drawings illustrate the best mode for carrying out the invention as presently contemplated and set forth herein after. Although the specific features of the embodiments herein are shown in one or more drawings, the features may not be restricted to the illustrated drawings. This is done for convenience only as each feature may be combined with any or all the other features in accordance with the embodiments herein. The features of the embodiments herein are described in drawings and of which a few are not shown in all. These features can be combined with any or all other features that exist in the embodiments disclosed herein. The present invention may be more clearly understood from a consideration of the following detailed description of the preferred embodiments taken in conjunction with the accompanying drawings in which:

FIG. 1 depicts the overview of current real estate transaction system, according to an embodiment of the present invention;

FIG. 2 depicts the novel system approach, according to another embodiment of the present invention;

FIG. 3 depicts the flow diagram of the conversational intent prediction, according to an additional embodiment of the present invention;

FIG. 4 depicts the data sample of the conversational intent prediction, according to another embodiment of the present invention;

FIG. 5 depicts the sample code of intent model training, according to a further embodiment of the present invention;

FIG. 6 depicts the dynamic multivariate bidding system, according to an embodiment of the present invention;

FIG. 7A depicts an AI realty advisor, according to an additional embodiment of the present invention;

FIG. 7B depicts an AI realty workflow automation AI realtor, according to another embodiment of the present invention;

FIG. 8 depicts the sample data comprising information about properties and buyers, according to yet another embodiment of the present invention;

FIG. 9A˜FIG. 9B depicts the sample code of AI realtor, according to a further embodiment of the present invention;

FIG. 10A˜FIG. 10B depicts the collaborative filtering-based recommendation in python, according to an additional embodiment of the present invention;

FIG. 11 depicts a system design flow of ML crawler (inspection, disclosure etc.), according to a further embodiment of the present invention;

FIG. 12 depicts a seller marketing tools, according to a furthermore embodiment of the present invention;

FIG. 13A depicts the sample code of the propensity model, according to another embodiment of the present invention;

FIG. 13B depicts the sample data of the propensity model, according to yet another embodiment of the present invention;

FIG. 14 depicts the buyer insights platform, according to an embodiment of the present invention;

FIG. 15A˜FIG. 15B depicts the sample code to get real estate transaction source data, according to another embodiment of the present invention;

FIG. 16A˜FIG. 16B, FIG. 16C depicts the sample code of encrypted negotiation portal, according to an additional embodiment of the present invention;

FIG. 17 depicts the group invested platform, according to an embodiment of the present invention;

FIG. 18A˜FIG. 18B depicts the sample code of the group invested platform, according to yet another embodiment of the present invention;

FIG. 19 depicts the system architecture for AI rental platform, according to a further embodiment of the present invention;

FIG. 20A˜FIG. 20B depicts the sample code of machine learning model to predict the likelihood of a particular tenant being approved, according to a furthermore embodiment of the present invention;

FIG. 21 depicts the sample data of machine learning model to predict the likelihood of a particular tenant being approved, according to an additional embodiment of the present invention; and

FIG. 22A˜FIG. 22B depicts the flowchart of a method of current real estate transaction, according to another embodiment of the present invention.

### DESCRIPTION

The exemplification set out herein illustrates an embodiment of the invention in one form, and such exemplification is not intended to be construed as limiting in any manner.

In order to forestall the drawbacks and disadvantages associated with earlier prior arts and to provide additional advantages, an intelligent real estate transaction system with personalized recommendations based on user preferences and intent is illustrated and explained herein. The following description is illustrative in nature and is not intended to be in any way limiting.

The various embodiments herein provide a conversational intent prediction with a technology that utilizes artificial intelligence (AI) and machine learning (ML) to analyze and understand buyer interactions in the real estate industry. Through chatbots, voice assistants, and other conversational interfaces, this technology enables real estate agents to engage with buyers in a personalized way, providing tailored recommendations and advice. By analyzing these interactions, conversational intent prediction of the embodiments herein can help agents identify potential buyers and predict which properties are most likely to sell quickly. The implementation of this technology has the potential to transform the real estate industry by improving customer experience, efficiency, and driving better business outcomes.

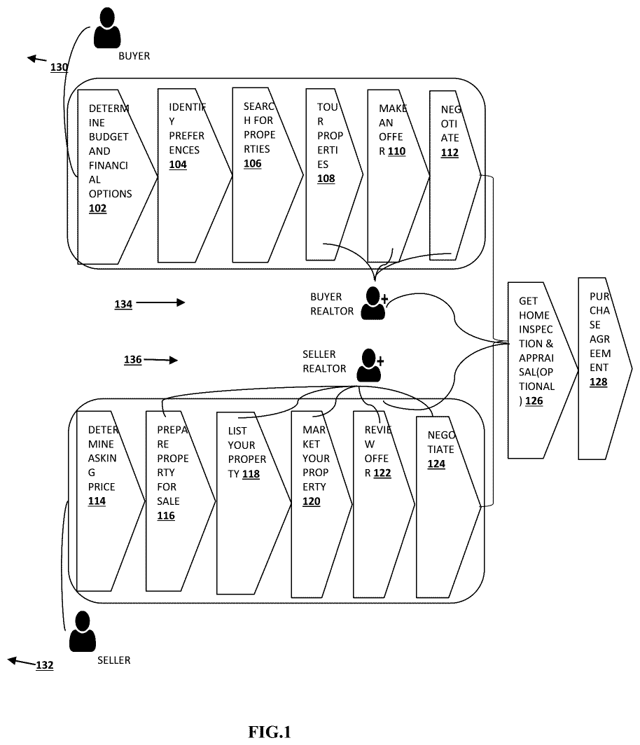

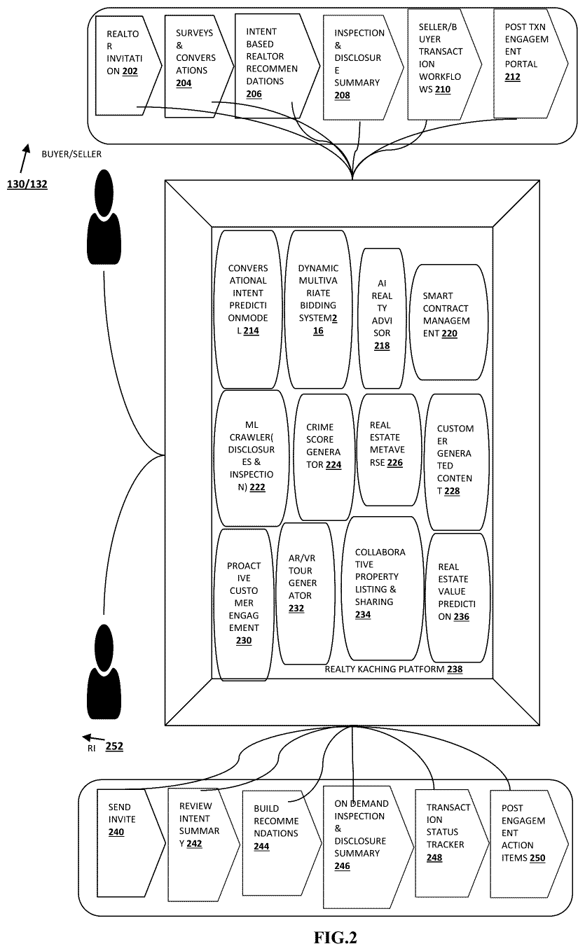

Referring now to FIG. 1, an embodiment of the present invention is explained herein. The drawings of FIG. 1 depict an overview of current real estate transaction system. The process of buying or selling a piece of real estate typically involves a number of steps, which may vary depending on the specific laws and regulations of the jurisdiction in which the property is located. Here is a general outline of the process. For the buyer 130, the process involves the following steps:
determining the budget and financing options 102 which involves working with a lender to secure a mortgage or saving up cash to make a cash offer;
identifying the preferences 104 by considering a plurality of factors including but not limited to location of the property interested in, size of the property, style of the property, kind of the property and the features of the property that is important to the buyer 130;
searching the properties 106 which involves a plurality of functions including but not limited to working with a real estate agent, browsing the listings online, or contacting the owners directly;
touring the properties 108 by scheduling such tours of properties that meet the criteria of the buyer 130 and taking up of notes or photos by the buyer 130 to help him compare his options;
making the offer 110 for the property identified by the buyer 130 for purchasing by working with his agent or lawyer to prepare an offer that includes the price, terms, and contingencies.
negotiating the accepted offer 112 accepted for the terms such as closing dates, repairs, or contingencies.
having the home inspection 126 by a professional inspector for checking the property for any defects or issues that may not be immediately apparent to the buyer 130;
finalizing the mortgage-based financing of the property bought by the buyer 130 by finalizing the loan agreement with the lender;
signing the purchase agreement 128 with the seller 132 in order to outline the terms of the sale; and
closing the deal by the payment of the agreed-upon amount by the buyer 130 to the seller 132.

For the seller 132, the real estate transaction process involves the following steps:
determining the offer price 114 by working with a real estate agent to review the comparable sales or conducting his own research to determine the value of his property;
preparing the property for sale 116 by making repairs or updates, decluttering, and staging the property to make it more attractive to buyer 130;
listing the property 118 by working with a real estate agent, or listing the property on your own through an online platform or classified advertisement;
marketing the property 120 by creating online listings, advertising through social media or other channels, or hosting open houses;
reviewing the offers 122 from potential buyers 130 and carefully determining which one is the best fit for his (seller's) needs;
negotiating the terms 124 including price, closing dates, or contingencies;
having the home inspection 126 on the request/demand by the buyer 130 from a professional home inspector to check the property;
signing the purchase agreement 128 with the buyer 130 in order to outline the terms of the sale; and
   closing the deal by transferring the ownership of the property to the buyer 130 and receiving the agreed-upon purchase price.

Referring now to FIG. 2, the novel system approach, according to one embodiment of the present invention is illustrated herein. The real estate industry is rapidly evolving with the advent of technology, and to keep up with the fast-paced changes, a novel system approach is needed. The system of the embodiments herein provides a comprehensive and innovative system approach for realtors 252 that incorporates advanced machine learning algorithms and cutting-edge technologies. The system approach includes various modules such as conversational intent prediction, multivariate bidding system, crime score generator, machine learning (ML) crawler for disclosures and inspections, automated documentation, real estate metaverse, customer-generated content, artificial intelligence (AI) rental platform, proactive customer engagement 230, collaborative property listing sharing 234, augmented reality (AR)/virtual reality (VR) tour generators 232, and real estate value prediction. These modules provide a holistic and seamless experience to realtors 252, improving the overall efficiency, transparency, and user satisfaction in the real estate transaction process.

The system uses machine learning algorithms to analyze market trends, property data, and client preferences to provide tailored recommendations and insights, maximizing profits for realtors 252 and providing the best possible service to clients. The system approach provides a comprehensive and innovative solution and advisor for realtors 252 and buyers 130 and sellers 132, using advanced technology and machine learning algorithms to provide highly personalized and efficient services to clients. The system of the embodiments herein has the potential to revolutionize the way realtors 252 do business, improving transparency, efficiency, and user satisfaction, and has significant implications for the future of the real estate market.

Conversational Intent Prediction 214: The intent model is predictive and interactive. Using conversational and interactive AI-driven chats, the system aims to understand the priorities and preferences of the buyer 130, and preferences to build a tailored intent model. The aim of the embodiments herein is to provide a summary to the broker on the best properties that may work for the buyer 130, based on their individual needs and preferences. By incorporating machine learning algorithms, the system of the present invention continually improves and updates the intent model, ensuring that it remains accurate and relevant to the buyer's 130 changing preferences.

Multivariate Bidding System 216: The multivariate bidding system 216 is designed to provide an efficient and flexible bidding process for buyers 130, sellers 132, and realtors 252. The system offers multiple types of bidding, including auction and first-across-the-post, giving users the ability to choose the option that best suits their needs. To ensure compliance, the system provides immediate documentation creation for bids, saving time and effort. The integration with popular messaging systems such as Apple, Facebook, and SMS make communication easier and more convenient for all parties involved in the bidding process. This also reduces misunderstandings and improves transparency. Real-time analytics provide users with valuable insights into bid activity, allowing them to make informed decisions and adjust their strategies accordingly. This enhances the chances of success for buyers 130 and sellers 132 and improves their overall experience. The system also offers customizable features for realtors 252, who can tailor the bidding process to meet their unique requirements. They can choose the type of bidding, the messaging systems to integrate with, and the approval mechanisms to use, providing a more personalized experience for their clients.

AI Realty Advisor 218: The AI Realty Advisor 218 is designed to provide realtors 252 with valuable insights and recommendations for their customers. Using conversational AI, the advisor helps realtors 252 prioritize customers and provides insights into their houses, inspection reports, and likely trends in their values. The advisor is able to analyze a variety of data sources, including market trends, property history, and customer preferences, to provide personalized insights and recommendations. This helps realtors 252 better understand their customer base and provide more relevant and useful information to their customers. It can also assist realtors 252 with property valuations, using machine learning algorithms to predict the likely value of a property based on various factors such as location, size, and condition. This provides realtors 252 with a more accurate and data-driven approach to property valuation, enhancing their credibility and improving their ability to meet customer needs.

Crime Score Generator 224: The crime Score Generator 224 provides realtors 252 and buyers 130 with valuable insights into the safety and security of different neighborhoods. Using a proprietary approach, the generator integrates both public and private data sources to generate sub-geographic crime scores. This allows users to make informed decisions about where to buy or sell properties, based on the safety and security of the surrounding neighborhoods. The crime scores are updated in real-time, ensuring that users always have access to the most up to date information.

ML Crawler for Disclosures and Inspections 222: The ML Crawler for Disclosures and Inspections 222 is a module that uses machine learning algorithms to automatically crawl through inspection reports and other documents related to a property. It is designed to extract key insights and issues related to the property that prospective buyers 130 are bidding on. This module can be highly beneficial for buyers 130, sellers 132 and realtors 252. For buyers 130, it can provide a comprehensive analysis of the property they are interested in, highlighting any potential issues that may need to be addressed before the sale can be finalized. This can save buyers 130 a significant amount of time and money, as they will not have to conduct their own inspections or hire outside experts to review the property. For sellers 132, the ML Crawler for Disclosures and Inspections 222 can help identify potential issues with their property before they are listed on the market. This can help sellers 132 address any issues before potential buyers 130 see the property, increasing the likelihood of a successful sale. For realtors 252, the ML Crawler for Disclosures and Inspections 222 can help realtors 252 streamline their workflow, make more informed decisions, and provide a better experience for their clients.

Smart Contract Management 220: The Smart Contract Management module 220 is designed to streamline the real estate transaction process using blockchain technology. The system uses smart contracts, which are self-executing contracts with the terms of the agreement between buyer 130 and seller 132 directly written into code. These smart contracts help to automate and manage the entire transaction process, from property listings to closing, with transparency and security. With this module, real estate transactions can be conducted in a more efficient and secure manner. All parties involved in the transaction can access the same information, and the smart contracts ensure that the terms of the agreement are automatically executed once they are met. This reduces the need for intermediaries, such as lawyers, and can save time and money for all parties involved. Additionally, the use of blockchain technology ensures that the transaction is secure and tamper-proof. The ledger records every transaction and updates to the contract, making it transparent and easily auditable. This eliminates the possibility of fraud or manipulation in the transaction process. It offers a comprehensive end-to-end solution for managing real estate transactions using blockchain technology. It ensures transparency, security, and efficiency, and reduces the need for intermediaries. Smart Contract Management 220 is an end-to-end solution for managing real estate transactions using blockchain technology. The system uses smart contracts to automate the entire transaction process, including property listings, offers, negotiations, and closing. The goal of this module is to ensure transparency, security, and efficiency in the real estate transaction process. The Smart Contract Management module 220 should be designed to handle various types of transactions, such as property listings, offers, and closing. Each transaction should have a corresponding smart contract that contains the terms of the transaction, including the price, conditions, and timelines. The smart contracts should be automated to ensure that the transaction process is streamlined and efficient.

The system should also be designed to ensure transparency and security. All transactions should be recorded on the blockchain and made visible to all parties involved in the transaction. The system should also have the necessary security measures in place to prevent fraudulent activities, such as identity theft and hacking.

Implementing Smart Contract Management 220 in real estate can provide several benefits, including reduced transaction costs, increased efficiency, and improved security. By using blockchain technology and smart contracts, real estate transactions can be automated and streamlined, providing a more transparent and secure transaction process for all parties involved.

Real Estate Metaverse 226: This module provides a virtual reality platform for real estate buyers 130 and sellers 132 to explore properties and neighbourhoods. The system uses advanced AR/VR technology to create immersive and interactive experiences for users, improving the overall user experience and engagement. Real estate metaverse 226 is a virtual world or platform where users can explore and interact with real estate properties. It is a digital representation of the physical real estate world, where users can virtually experience and navigate properties in a highly immersive and interactive way. The implementation of a real estate metaverse 226 involves the use of VR and AR technologies to create a virtual environment that mimics the real world. The platform can be accessed through a VR headset, a mobile device, or a computer, allowing users to explore properties from anywhere in the world.

The real estate metaverse 226 platform can include features such as 3D models of properties, interactive property listings, virtual tours, and even the ability to customize and design virtual spaces. It can also allow for social interactions between users, such as virtual open houses and meetings with real estate agents. Integration with blockchain technology may also be necessary to provide secure and transparent real estate transactions within the virtual environment. A real estate metaverse 226 can provide a highly engaging and immersive experience for potential buyers and investors 1704, allowing them to explore properties in a highly realistic and interactive way without the need for physical visits. This can also save time and resources for real estate agents and companies, as well as providing a platform for marketing and showcasing properties to a wider audience.

Customer-Generated Content 228: This module encourages users to generate and share content about their real estate experiences, such as reviews and testimonials. The system uses this content to improve the overall user experience and provide social proof to other potential buyers and sellers 132. Platform provides self-service tools for customers to create their own content, such as brochures, open houses, mailers, and campaigns. The platform offers easy-to-use templates and design tools that allow the customers to create professional-looking content without the need for specialized design skills. The platform also provides features to personalize the content with property-specific information and images. Customers can then distribute the content through various channels, including email, social media, and print. By empowering customers to create their own content, we enable them to take an active role in the marketing of their properties, while also saving time and resources for realtors 252. Customer-generated content 228 refers to any marketing materials or content that is created by the customers themselves, rather than by the company. In the context of real estate, customer-generated content 228 can include brochures, open houses, mailers, and campaigns that are created and shared by buyers 130 and sellers 132. The use of customer-generated content in real estate marketing can be beneficial in several ways. First, it can help to build trust and credibility with potential buyers and sellers 132, as they are more likely to trust and value the opinions and experiences of their peers. Second, it can be a cost-effective way for real estate agents to market their services and properties, as they can leverage the networks and resources of their clients.

To implement a customer-generated content 228 strategy, real estate agents can provide their clients with tools and resources to create and share their own content. This can include templates for brochures or flyers, social media campaigns, and virtual tour creation tools. Agents can also encourage their clients to share their experiences and opinions through online reviews and testimonials, which can be a powerful marketing tool. Incorporating customer-generated content 228 into a real estate marketing strategy can help to enhance brand awareness, build trust and credibility, and provide cost-effective marketing opportunities.

Proactive Customer Engagement 230: Proactive Customer Engagement 230 enables lifetime management of customers for realtors 252 based on personalized insights on the property they bought. The system uses data analytics and machine learning algorithms to track customer behaviour and provide personalized recommendations to realtors 252 on how to engage with their customers. For example, the system might remind a realtor 252 to follow up with a customer who recently purchased a property to ask if they need any assistance with fixing roof issues. By engaging with customers in a proactive manner, realtors 252 can build stronger relationships with their customers, increase customer loyalty, and ultimately drive more business.

Proactive customer engagement 230 involves the lifetime management of customers for realtors 252 based on personalized insights about the properties they have bought. The system uses data analytics and machine learning algorithms to track customer behaviour and provide personalized recommendations to realtors 252 on how to engage with their customers. For example, the system might remind a realtor 252 to follow up with a customer who recently purchased a property to ask if they need any assistance with fixing roof issues. By engaging with customers in a proactive manner, realtors 252 can build stronger relationships with their customers, increase customer loyalty, and ultimately drive more business.

To implement proactive customer engagement 230, real estate companies can use customer relationship management (CRM) software and machine learning algorithms to analyse customer data and generate insights. These insights can be used to create targeted and personalized marketing campaigns, as well as to provide realtors 252 with recommendations on how to engage with their customers. Automated messaging systems can also be used to send timely and personalized messages to customers, such as reminders about upcoming maintenance or home inspections. By leveraging technology in this way, real estate companies can provide a higher level of service to their customers, which can ultimately lead to increased customer satisfaction and loyalty.

Collaborative Property Listing Sharing 234: Collaborative Property Listing Sharing 234 provides a platform for real estate agents and brokers to share and collaborate on property listings. The system uses machine learning algorithms to match properties with potential buyers and sellers 132, improving efficiency and maximizing profits for all parties. Collaborative property listing 234 and buying refers to the process of multiple parties working together to buy or sell a property. Traditionally, the real estate buying and selling process involves a single agent representing the buyer 130 or seller 132. However, with collaborative property listing 234 and buying, multiple parties can work together to achieve a common goal. One way to implement collaborative property listing 234 and buying is through online platforms or marketplaces that allow multiple parties to participate in the buying or selling process. These platforms can facilitate the sharing of information and resources between buyers 130, sellers 132, and agents. For example, a buyer 130 and seller 132 could work together to find a common agent who can represent both parties in the transaction. This agent can help the parties negotiate a fair price and ensure that both parties' interests are represented. Additionally, online market places can provide access to listings from multiple sources, making it easier for buyers 130 and sellers 132 to find properties that match their needs. Collaborative property listing 234 and buying can provide several benefits, including:
With multiple parties involved, there is greater transparency in the buying and selling process, leading to fewer misunderstandings and disputes.
By sharing resources, buyers 130 and sellers 132 can reduce costs associated with the buying and selling process.
Collaboration can help streamline the buying and selling process, leading to faster and more efficient transactions.
Collaborative property listing 234 and buying can result in better outcomes for both buyers 130 and sellers 132, as both parties have a greater understanding of each other's needs and can work together to achieve a mutually beneficial outcome.

AR/VR Tour Generators 232: Platform provides an AR/VR tour generator for properties, allowing users to explore and interact with properties from the comfort of their own homes. The system uses advanced AR/VR technology to create realistic and interactive experiences for users, improving engagement and overall user experience.

Real Estate Value Prediction 236: Real estate value prediction 236 is a key aspect of the real estate industry, as it helps buyers 130, sellers 132, and agents make informed decisions about property transactions. There are various factors that drive real estate value, such as location, size, amenities, and more. Among these factors, school ratings and crime ratings are key variables that influence real estate value. Real estate value prediction 236 is a key aspect of the real estate industry, as it helps buyers 130, sellers 132, and agents make informed decisions about property transactions. There are various factors that drive real estate value, such as location, size, amenities, and more. Among these factors, school ratings and crime ratings are key variables that influence the real estate value.

Using public and private data, the real estate value prediction 236 system can generate predictions on these variables to help realtors 252 and buyers 130 make better decisions. For instance, school ratings are important to families with children, and properties located in areas with good schools often command higher prices. By leveraging public data on school ratings and other demographic factors, as well as private data on buyer 130 preferences and search history, the system can generate predictions on which properties are likely to appeal to families with children.

Similarly, crime ratings are important factors that influence real estate value, as properties located in areas with low crime rates are generally more desirable. The system can analyse crime data from various sources, including public data from law enforcement agencies, and private data from the own customer database, to generate predictions on which areas are likely to have low crime rates and hence be more attractive to buyers 130.

By providing accurate predictions on these key underlying variables, the real estate value prediction 236 system can help realtors 252 and buyers 130 make informed decisions about property transactions. This can lead to better outcomes for all parties involved, including higher sales prices for sellers 132 and better property matches for buyers 130.

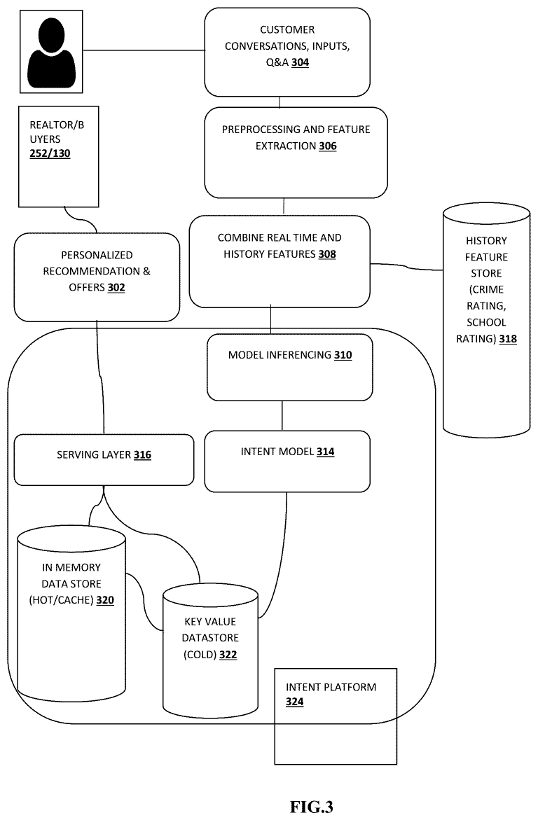

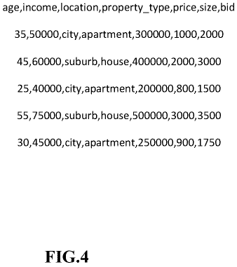

FIG. 3 depicts the flow diagram of the conversational intent prediction, according to one embodiment herein. The real estate intent prediction model is fed data from two sources: customer data and real estate data. The customer data includes information about the customer's behaviour, preferences, and demographics, and is used to predict the customer's intent to buy or rent a property. The real estate data includes information about the properties themselves, such as location, price, size, and features, and is used to help the model make more accurate predictions. The intent model 314 uses this data to make predictions about the customer's intent to buy or rent a property, and outputs the predicted intent as a probability or classification. The customer activity (IP address, location, website scroll, and browsing history) is collected from the customer's interactions with the website and sent to the intent platform API server 1224. The API server 1224 processes the activity data and sends it to the behavioural model, which uses machine learning techniques to build a model of the customer's buying intent. The behavioural model then generates personalized offers based on the customer's predicted buying intent and sends them back to the API server 1224. The API server 1224 passes the personalized offers back to the customer, who can then review and respond to them. The intent model 314 is a predictive and interactive system designed to provide real estate brokers with personalized recommendations for properties that are likely to meet their clients' needs and preferences. The system employs conversational and interactive AI-driven chats to understand the buyer's 130 priorities and preferences and builds a tailored intent model based on that information. To build the intent model 314, the system uses machine learning algorithms to analyse the data collected from the chats, such as the buyer's 130 preferred location, price range, and property features.

The system can also incorporate external data sources, such as crime rates and school ratings, to enhance the accuracy of the predictions. Once the intent model 314 is established, the system can provide the broker with a summary of the best properties that may work for the buyer 130, based on their individual needs and preferences. The system continually updates the intent model 314 using machine learning algorithms, ensuring that it remains accurate and relevant to the buyer's 130 changing preferences.

The benefits of this system include enhanced efficiency and accuracy for brokers, who can quickly provide their clients with personalized property recommendations, and improved customer satisfaction, as buyers 130 are more likely to find properties that meet their individual needs and preferences.

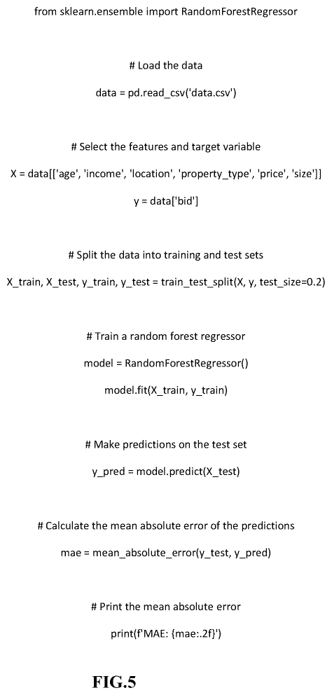

FIG. 4 depicts the data sample of the conversational intent prediction, according to one embodiment herein.

FIG. 5 depicts the sample code of intent model training, according to one embodiment herein.

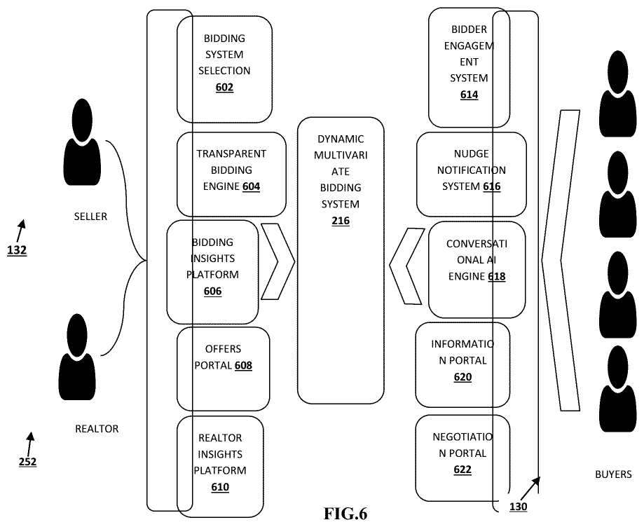

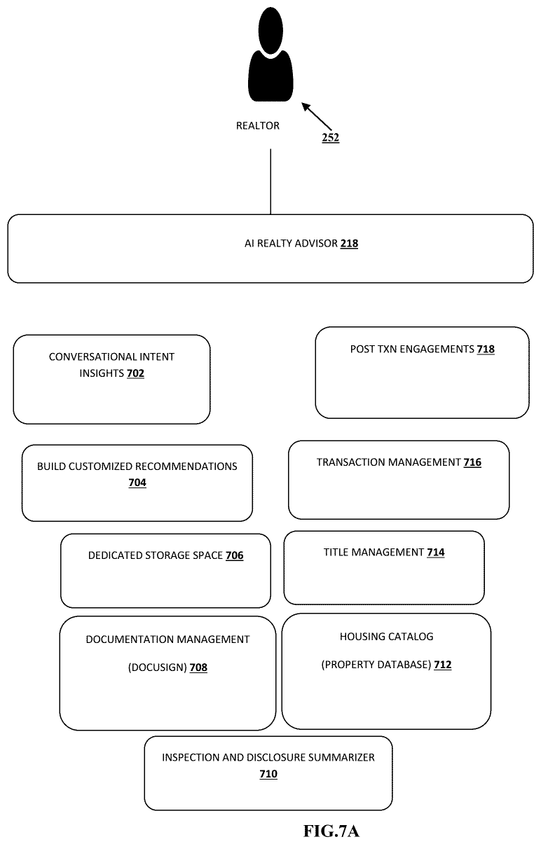

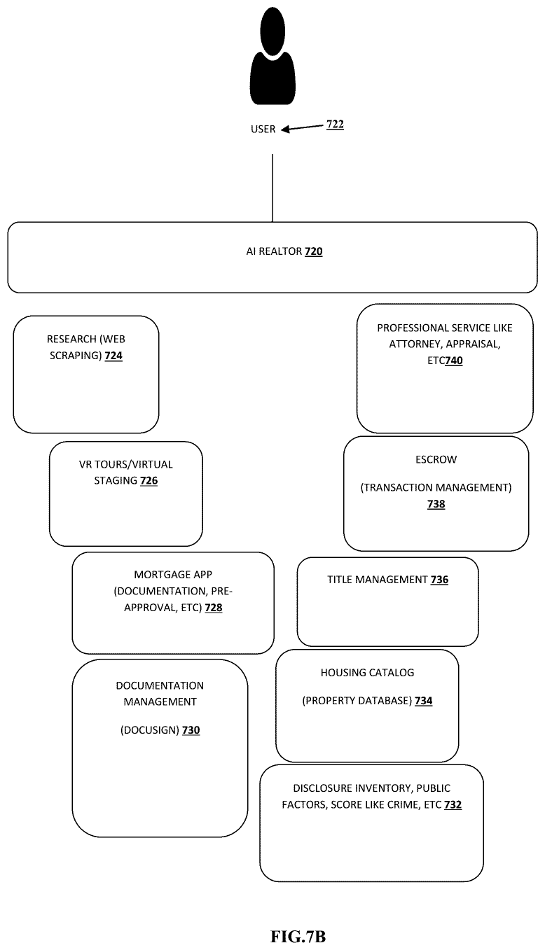

FIG. 6 depicts the dynamic multivariate bidding system 216, according to one embodiment herein. Current Real Estate bids are run manually by a realtor 252 and prospective buyers 130 submit bids to the realtor 252 who aggregates and works with the seller 132. The system of the present invention will offer a digital e-auction platform that meets the compliance requirements of each US state and allows sellers 132 to list their properties in an open bidding platform and that will engage and inform bidders and buyers 130 in real time and nudge them with real time information based on their engagement with the platform.

The seller 132 interacts with the bidding system 216, which is implemented as an API server 1224. The bidding system 216 uses machine learning techniques to optimize the value of the property being sold and map the seller 132 to specific bidding systems that are designed to maximize the value of the property.

Each of these bidding systems 216 is tailored to the specific needs and goals of the seller 132 and may use different strategies and techniques to optimize the value of the property. For example, one bidding system 216 might focus on attracting a high volume of bids, while another might target specific buyers 130 with a higher propensity to pay a premium price.

Seller 132: The seller 132 is an individual or entity selling a property. They interact with the bidding system 216 through a web interface or a mobile app.

Bidding System 216: The bidding system 216 is the main component of the system, implemented as an API server 1224. It uses machine learning techniques to optimize the value of the property being sold and maps the seller 132 to specific bidding systems that are designed to maximize the value of the property.

Property Value Optimization: The property value optimization module uses machine learning techniques to analyse various factors that influence the value of the property, such as location, size, features, and market conditions. It then uses this analysis to identify strategies and techniques that are most likely to optimize the value of the property.

Current real estate bids are run manually by a realtor 252 and prospective buyers 130 submit bids to the realtor 252 who aggregates and works with the seller 132. The system of the present invention will offer a digital e-auction platform that meets the compliance requirements of each US state and allows sellers 132 to list their properties in an open bidding platform and that will engage and inform bidders and buyers 130 in real time and nudge them with real time information based on their engagement with the platform. The seller 132 interacts with the bidding system, which is implemented as an API server 1224. The bidding system uses machine learning techniques to optimize the value of the property being sold and maps the seller 132 to specific bidding systems that are designed to maximize the value of the property.

Each of these bidding systems is tailored to the specific needs and goals of the seller 132 and may use different strategies and techniques to optimize the value of the property. For example, one bidding system might focus on attracting a high volume of bids, while another might target specific buyers with a higher propensity to pay a premium price.

Seller 132-Specific Bidding Systems: The seller 132-specific bidding systems module maps the seller 132 to specific bidding systems that are tailored to their needs and goals. These bidding systems may use different strategies and techniques to optimize the value of the property, such as targeting specific buyers or attracting a high volume of bids.

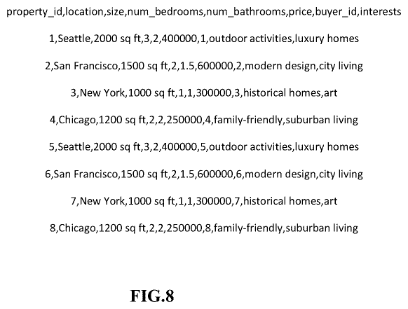

FIG. 7A depicts an AI realty advisor 218, according to one embodiment herein. The AI Realty Advisor 218 is an innovative tool designed to provide realtors 252 with valuable insights and recommendations for their customers. The tool utilizes conversational AI to help realtors 252 prioritize customers and provides insights into their houses, inspection reports, and likely trends in their values. By analyzing various data sources such as market trends, property history, and customer preferences, the AI Realty Advisor 218 provides personalized insights and recommendations to realtors 252. This helps realtors 252 better understand their customer base and provide more relevant and useful information to their customers. The tool also helps realtors 252 with property valuations, using machine learning algorithms to predict the likely value of a property based on various factors such as location, size, and condition. This enhances realtors' 252 credibility and improves their ability to meet customer needs. The AI Realty Advisor 218 is an excellent solution for realtors 252 looking to improve their customer engagement and provide more accurate and data-driven property valuations. With the use of AI and machine learning, the tool continually improves and provides realtors 252 with up-to-date insights and recommendations. This diagram shows the various components of the AI Realty Advisor 218 and how they work together to provide an automated end-to-end workflow solution for realtors 252 to help their buyers effectively.

FIG. 7B depicts an AI realty workflow automation AI realtor, according to one embodiment herein. An AI realtor 720 is a type of artificial intelligence (AI) system that is designed to assist realtors in their work. System designed architecture for an AI realtor 720 that provides an automated end-to-end workflow solution for buyers 130 to bid on a house. This diagram shows the various components of the AI realtor 720 and how they work together to provide an automated end-to-end workflow solution for buyers 130 to bid on a house.

The buyer 130 initiates the process by interacting with the AI realtor 720, which is implemented as an API server 1224. The AI realtor 720 then retrieves information about the property and the local real estate market through web scraping and VR tours. It also provides a mortgage calculator to help the buyer 130 understand their financing options. Once the buyer 130 is ready to make an offer, the AI realtor 720 helps them manage the necessary documents through DocuSign 730 and generates a disclosure inventory to provide transparency about the condition of the property. The AI realtor 720 also maintains a database of properties for sale and helps manage the title transfer process through escrow. Finally, the AI realtor 720 provides attorney management to ensure that all legal requirements are met.

Buyer 130: The buyer 130 is an individual or entity interested in purchasing a property. They interact with the AI realtor 720 through a web interface or a mobile app.

AI Realtor 720: The AI realtor is the main component of the system, implemented as an API server 1224. It provides a range of services to the buyer 130, including research, VR tours, mortgage calculations, document management, disclosure inventory, property listings, title management, escrow, and attorney management.

Research 724: The research module 724 retrieves information about the property and the local real estate market through web scraping. This may include data such as property listings, prices, descriptions, and photographs.

VR Tours 726: The VR tours module 726 provides VR tours of the property, allowing the buyer 130 to explore the property remotely. This can be especially useful for buyers 130 who are unable to physically visit the property due to geographic distance or travel restrictions.

Mortgage App 728: The mortgage app module 728 provides a financial calculator that helps the buyer 130 understand their financing options and estimate the monthly mortgage payments for the property.

DocuSign 730: The DocuSign module 730 helps the buyer 130 manage the necessary documents for the sale, such as the purchase agreement and mortgage application. It allows the buyer 130 to sign and transmit documents electronically, saving time and eliminating the need for in-person meetings.

Disclosure Inventory 732: The disclosure inventory module 732 generates a list of items that are included in the sale of the property, such as appliances, fixtures, and any visible damage. This helps provide transparency to the buyer 130 about the condition of the property.

House Catalog 734: The house catalog module 734 maintains a database of properties for sale, including information such as location, size, features, and asking price. The buyer 130 can use this database to browse available properties and make informed purchasing decisions.

Title Management 736: The title management module 736 helps manage the process of transferring ownership of the property from the seller 132 to the buyer 130. This may include tasks such as verifying the ownership of the property, issuing a new title in the buyer's name, and ensuring that all legal requirements are met.

Escrow 738: The escrow module 738 handles the financial aspects of the sale, including the collection and disbursement of funds. It acts as a neutral third party to hold and protect the funds until the sale is complete, at which point the funds are released to the appropriate parties.

Professional Service Management 740: The attorney management module provides legal support to the buyer 130 and seller 132, including reviewing and drafting documents, negotiating terms, and ensuring that all legal requirements are met.

FIG. 8 depicts the sample data comprising information about properties and buyers, according to one embodiment herein. This data includes information about properties (location, size, number of bedrooms, number of bathrooms, and price) and 8 buyers 130 (buyer ID and interests). The data could be used to train a machine learning model to predict which buyers 130 are most likely to be interested in a particular property. This is just a simple example, and a real recommendation model would likely include additional features such as property and buyer 130 demographics, browsing history, and other behavioral data.

Seller 132/Buyer 130 Recommendation Engine comprises user interface, buyer recommendation engine, seller 132 recommendation engine, property database, User Accounts and Authentication, Integration with External Services, Security and Compliance, Buyer Recommendation, Seller 132 Recommendation.

User Interface: This includes the web or mobile application that buyers 130 use to access the recommendation engine. The interface should be easy to use and allow buyers 130 to input their interests and preferences and for sellers 132 to input information about their properties.

Buyer Recommendation Engine: This is the core component of the system that generates recommendations for buyers 130. It should be able to process user input (e.g., interests and preferences) and generate a list of recommended properties.

Seller 132 Recommendation Engine: This is the core component of the system that generates recommendations for sellers 132. It should be able to process property information and generate a list of potential buyers who are most likely to be interested in the property.

Property Database: This component stores information about properties that are available for sale, including details such as location, size, and features.

User Accounts and Authentication: This component handles user registration, login, and authentication. It should ensure that only authorized users can access the recommendation engine.

Integration with External Services: The platform may need to integrate with external services such as payment gateways or email marketing platforms.

Security and Compliance: The platform should have strong security measures in place to protect user data and ensure compliance with relevant regulations.

This is just a simple example, and a real recommendation engine would likely include additional functionality such as support for more advanced scoring models, integration with external data sources, and support for personalized recommendations.

Buyer Reco: Buyer 130 accesses the recommendation engine through the user interface (e.g., a web or mobile application). Buyer 130 inputs their interests and preferences (e.g., location, budget, number of bedrooms). The recommendation engine processes the user input and generates a list of recommended properties based on the interests and preferences. The recommendation engine returns the list of recommended properties to the user interface. The user interface displays the recommended properties to the buyer 130.

The buyer 130 can browse the recommended properties and request more information or schedule a viewing. This is just a simple example, and a real recommendation engine workflow would likely include additional steps such as authentication, integration with external services, and tracking and analysis of user behavior.

Seller Reco: Seller 132 accesses the recommendation engine through the user interface (e.g., a web or mobile application). The Seller 132 inputs information about their property (e.g., location, size, features). The recommendation engine processes the property information and generates a list of potential buyers who are most likely to be interested in the property. The recommendation engine returns the list of potential buyers to the user interface. The user interface displays the potential buyers to the seller 132. Seller 132 can browse the potential buyers and initiate contact with them. This is just a simple example, and a real recommendation engine workflow would likely include additional steps such as authentication, integration with external services, and tracking and analysis of user behavior.

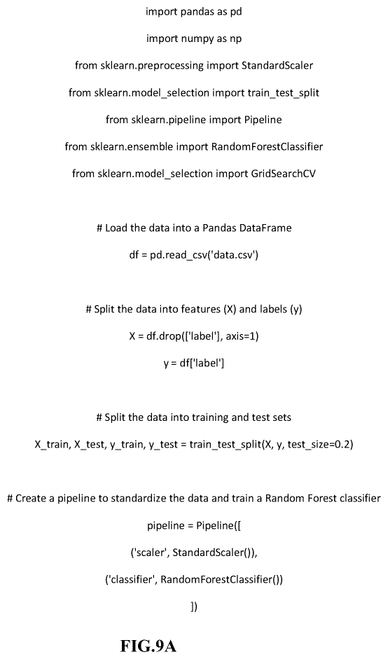

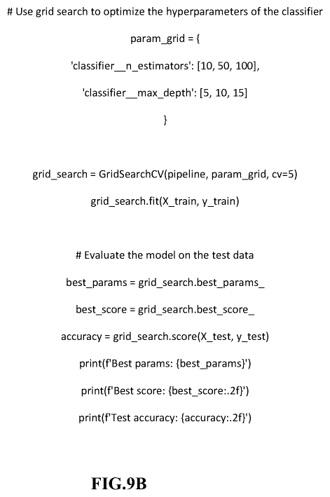

FIG. 9A˜FIG. 9B depicts the sample code of AI realtor, according to one embodiment herein. This example uses a pipeline to standardize the data and train a Random Forest classifier. It also uses grid search to optimize the hyperparameters of the classifier. The model is then evaluated on the test data to assess its performance.

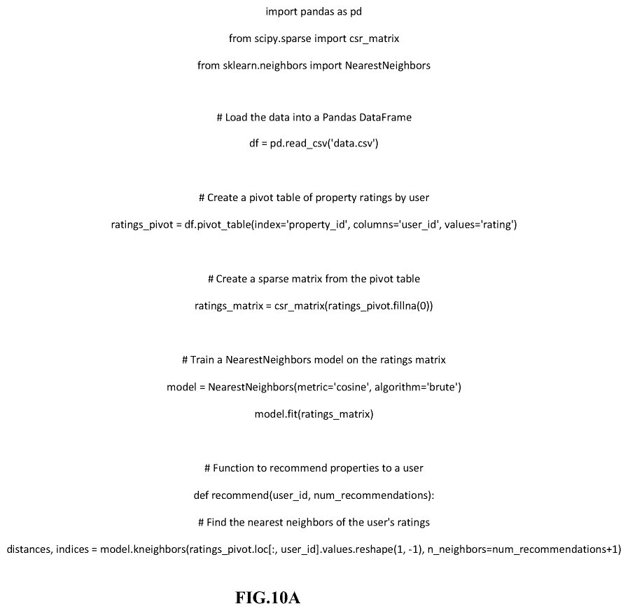

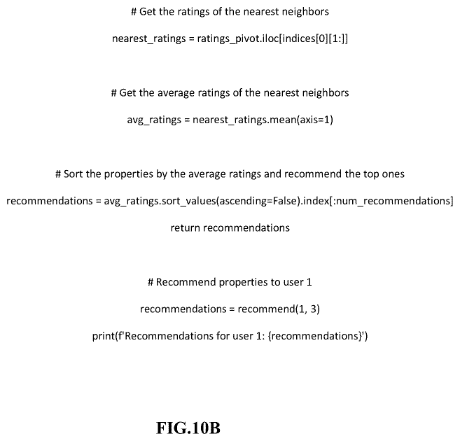

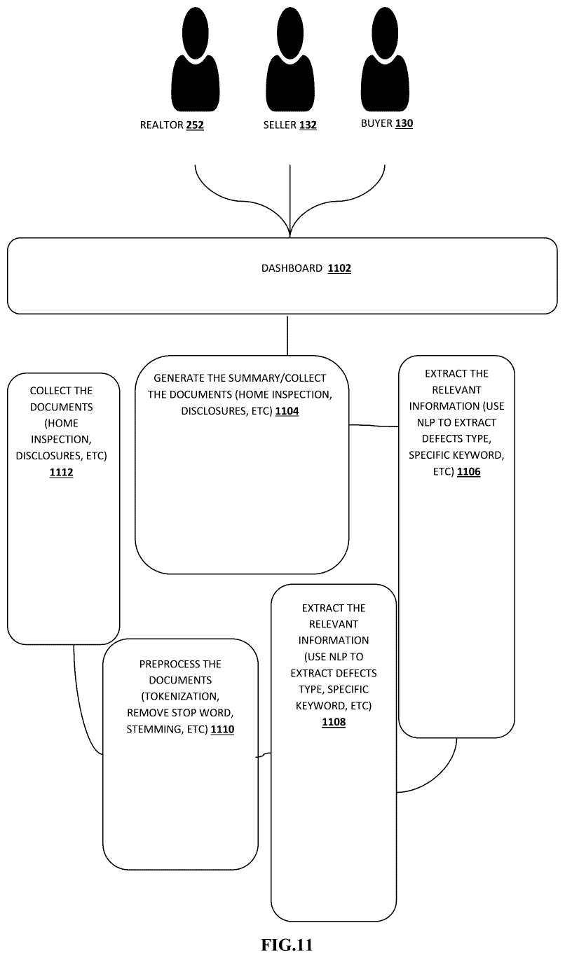

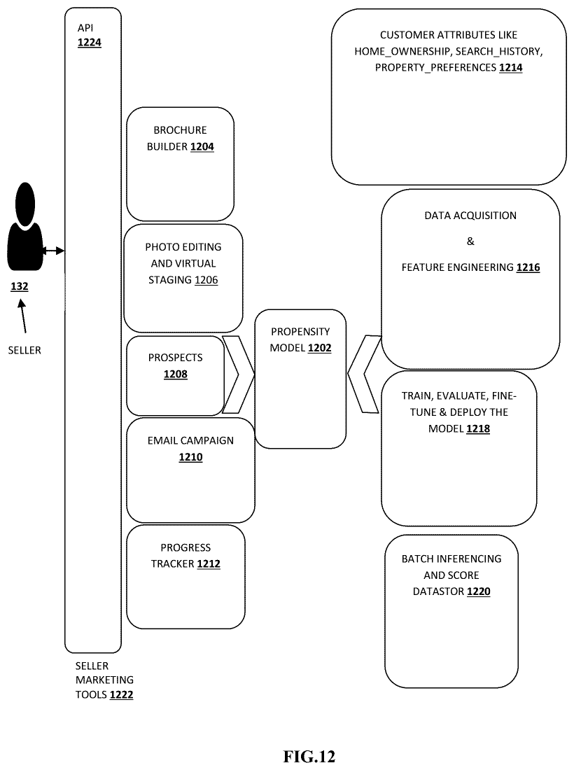

FIG. 10A˜FIG. 10B depicts the collaborative filtering-based recommendation in python, according to one embodiment herein. This example uses a pivot table to create a matrix of property ratings by user and trains a Nearest Neighbors model on the matrix. It then defines a function to recommend properties to a user based on the ratings of the user's nearest neighbors in the model.

Seller/Buyer matching engine: A real estate seller and buyer matching engine is a system that helps match sellers of real estate properties with potential buyers. The goal of such a system is to facilitate the process of buying and selling real estate by bringing together sellers 132 and buyers 130 who are interested in the same types of properties.

To design a real estate seller 132 and buyer matching engine, there are several key steps that need to be taken:
Define the target market: The first step in designing a real estate seller 132 and buyer matching engine is to define the target market. This will determine which types of properties the system will focus on and which buyers 130 and sellers 132 it will aim to match;
Determine the features and criteria for matching: The next step is to determine the features and criteria that the system will use to match buyers 130 and sellers 132. This may include factors such as location, price range, number of bedrooms and bathrooms, and other property characteristics;
Collect and organize data: To match buyers 130 and sellers 132, the system will need to have access to a database of real estate properties. This data will need to be collected and organized in a way that allows the system to search and filter properties based on the defined features and criteria;
Develop the matching algorithm: The next step is to develop the algorithm that will be used to match buyers 130 and sellers 132. This may involve using machine learning techniques to analyse the data and identify patterns that can be used to predict which buyers 130 are most likely to be interested in which properties;
Test and refine the algorithm: Before the system is deployed, it is important to test the algorithm and make any necessary refinements. This may involve using a sample dataset to see how well the algorithm is able to match buyers 130 and sellers 132 and adjusting as needed;
Integrate the system into a platform: Once the algorithm has been developed and tested, it can be integrated into a platform that allows buyers 130 and sellers 132 to search and browse properties and initiate contact with one another. This may be a website, a mobile app, or some other type of platform.

There are many different algorithms that could potentially be used in a real estate seller 132 and buyer matching engine. The specific algorithm or algorithms that you choose to use will depend on the requirements of your system and the type of data you are working with. Here are some examples of algorithms that you might consider using:
Classification algorithms: Classification algorithms are used to predict the class or category of an item based on a set of features. For example, you might use a classification algorithm to predict whether a property is likely to be a good match for a particular buyer 130 based on the buyer's preferences and the characteristics of the property. Some examples of classification algorithms include decision trees, logistic regression, and support vector machines;
Clustering algorithms: Clustering algorithms are used to group items together based on their similarity. For example, you might use a clustering algorithm to group properties into categories based on their location, price range, or other characteristics. Some examples of clustering algorithms include k-means and hierarchical clustering;
Collaborative filtering algorithms: Collaborative filtering algorithms are used to make recommendations based on the preferences of other users. For example, you might use a collaborative filtering algorithm to recommend properties to buyers 130 based on the properties that other buyers 130 with similar preferences have shown interest in;
Association rule learning algorithms: Association rule learning algorithms are used to identify relationships between items in a dataset. For example, you might use an association rule learning algorithm to identify patterns in the properties that buyers 130 are interested in, such as the fact that buyers 130 who are interested in properties in a certain price range are also likely to be interested in properties with a certain number of bedrooms. Some examples of association rule learning algorithms include a priori and FP-growth;
Deep learning algorithms: Deep learning algorithms are a type of machine learning algorithm that are inspired by the structure and function of the human brain. They are particularly well-suited to tasks that involve large amounts of data and complex patterns. Some examples of deep learning algorithms include convolutional neural networks (CNNs) and recurrent neural networks (RNNs).

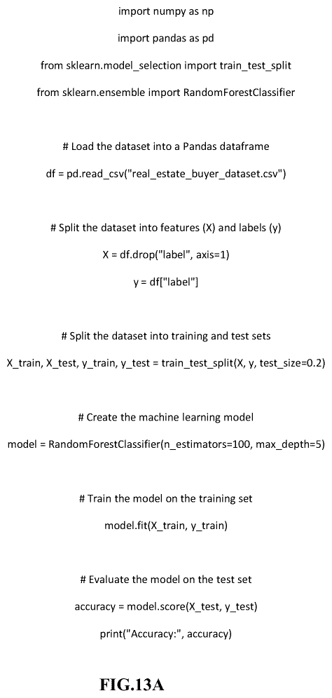

FIG. 11 depicts a system design flow of ML crawler (inspection, disclosure etc.), according to one embodiment herein. Inspection summaries are useful in real estate transactions because they provide a summary of the findings of a home inspection, which is a detailed examination of the condition of a property. Home inspections are typically conducted by professional home inspectors and are intended to identify any issues or deficiencies with the property. These issues may include structural problems, electrical or plumbing issues, or other types of defects. Having an inspection summary is helpful for both buyers 130 and sellers 132 of real estate properties because it provides a clear and concise overview of the condition of the property. For buyers 130, an inspection summary can help them understand the potential costs and risks associated with purchasing the property.

For seller 132, an inspection summary can help them understand any issues that may need to be addressed before the property can be sold. Inspection summaries are often used as part of the negotiation process in real estate transactions. For example, a buyer 130 may use an inspection summary to negotiate a lower price for the property or to request that the seller 132 make certain repairs or improvements before the sale is finalized. Similarly, a seller 132 may use an inspection summary to negotiate a higher price or to provide evidence that the property is in good condition.

Obtain a copy of the home inspection report 1112: The home inspection report is a document that is produced after a professional inspection of a home. It typically details any issues or deficiencies found during the inspection, along with recommendations for repairs or further evaluation.

Use NLP techniques to extract relevant information 1108: Once you have a copy of the report, you can use natural language processing (NLP) techniques to extract relevant information from the text. This may involve tokenizing the text (splitting it into individual words), performing part-of-speech tagging (identifying the role of each word in the sentence), and identifying named entities (such as the names of specific parts of the home or types of defects).

Use machine learning techniques to classify the information: After extracting the relevant information from the report, you can use machine learning techniques to classify it into predefined categories. For example, you might classify issues as being related to the roof, electrical system, or plumbing, or you might classify them as being major or minor. There are various algorithms and approaches you can use for this task, such as decision trees, support vector machines, or neural networks.

Generate summary highlights 1104: Once you have classified the information from the report, you can use it to generate summary highlights. This could involve creating a list of the most significant issues identified in the report or generating a summary of the overall condition of the home. You can use classified information to prioritize the issues and present them in a clear and concise manner.

FIG. 12A˜FIG. 12B depicts a seller 132 marketing tools, according to one embodiment herein. System design for seller 132 marketing tools 1222 that help sellers 132 build their own brochures, market, and target potential buyers, identify high propensity buyers, and track progress. This diagram shows the various components of the marketing tools and how they work together to help sellers 132 market and sell their properties. The seller 132 interacts with the marketing tools 1222, which are implemented as an API server 1224. The marketing tools 1222 provide a range of services to the seller 132, including a brochure builder 1204, marketing and targeting tools, a propensity model 1202, email campaigns 1210, and progress tracking 1212. The brochure builder 1204 allows the seller 132 to create professional-quality brochures for their properties. The marketing and targeting tools 1222 help the seller 132 reach potential buyers through various channels, such as social media, search engine marketing, and email marketing. The propensity model 1202 uses machine learning techniques to identify high propensity buyers based on their past behavior and other factors. This helps seller 132 target their marketing efforts more effectively. The email campaigns module 1210 helps the seller 132 send targeted emails to potential buyers and track the progress of their campaigns. The progress tracking module 1212 provides metrics and analytics on the seller's 132 marketing efforts, allowing them to track their success and make informed decisions about their marketing strategy.

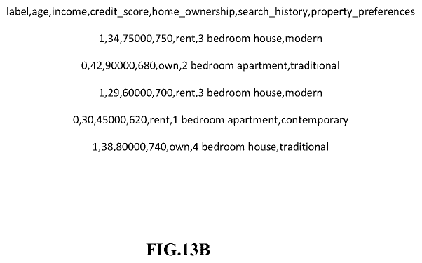

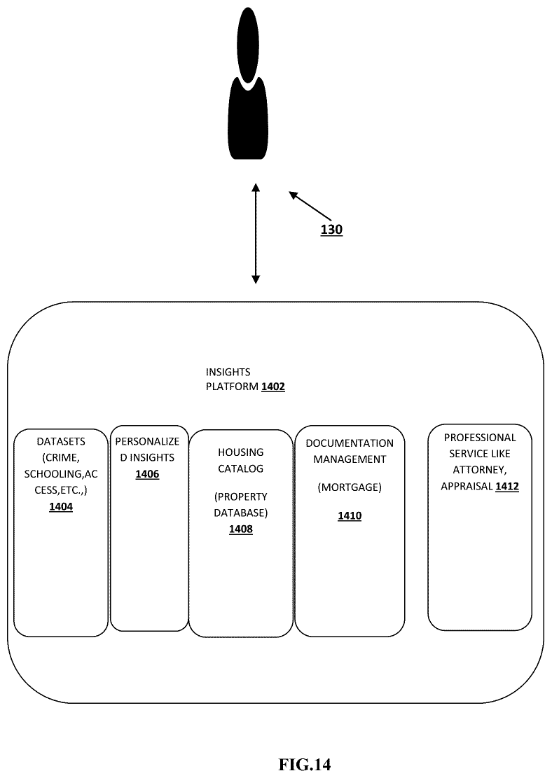

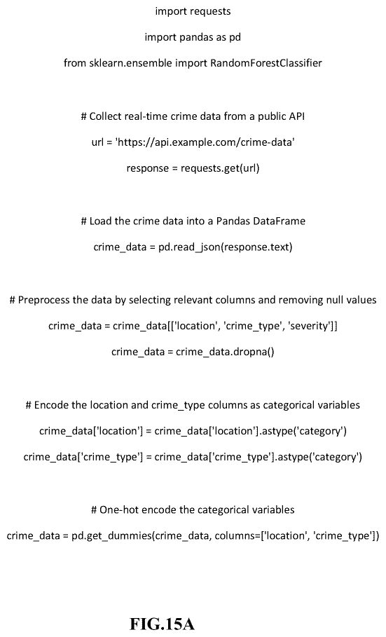

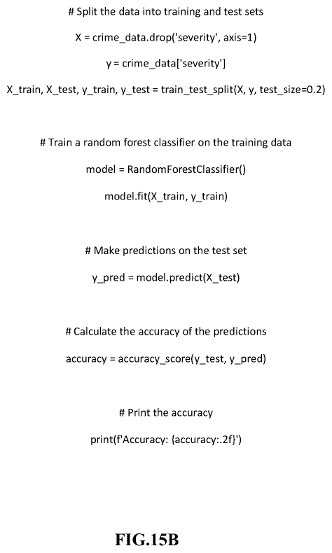

FIG. 13A depicts a sample code of the propensity model, according to one embodiment herein. The sample code is designed to predict the likelihood that a user will take a specific action, such as buying a piece of real estate. A complex propensity model may incorporate a wide range of data sources and features to more accurately predict user behavior.

FIG. 13B depicts a sample data of the propensity model, according to one embodiment herein.

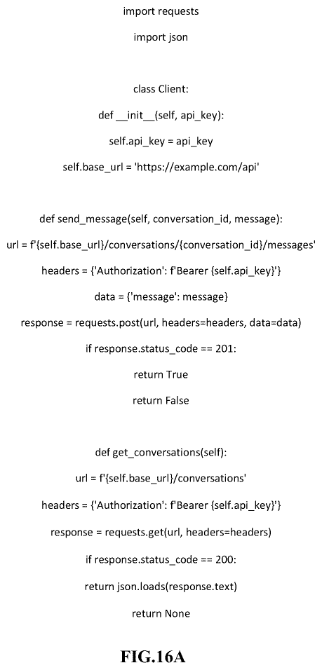

FIG. 14 depicts the buyer insights platform 1402, according to one embodiment herein. System design for a buyer insights platform 1402 that overlays data sets such as crime data, schooling data, accessibility data, and property tax data on the interests and behavior of buyers 130: This diagram shows the various components of the buyer insights platform 1402 and how they work together to provide personalized insights to buyers. The buyer 130 interacts with the insight's platform 1402, which is implemented as an API server 1224. The insights platform 1402 accesses a range of data sets 1404, such as crime data, schooling data, accessibility data, and property tax data, and overlays them on the buyer's interests and behavior. This allows the platform 1402 to provide personalized insights to the buyer 130 about the properties they are interested in.

For example, if the buyer is interested in a property in a particular location, the platform might use the crime data and schooling data to provide insights about the safety and quality of the area. Similarly, the accessibility data and property tax data might be used to provide insights about the case of access to the property and the associated costs.

Buyer 130: The buyer is an individual or entity interested in purchasing a property. They interact with the insight's platform 1402 through a web interface or a mobile app.

Insights Platform 1402: The insights platform 1402 is the main component of the system, implemented as an API server 1224. It provides personalized insights to the buyer 130 based on their interests and behavior, as well as a range of data sets such as crime data, schooling data, accessibility data, and property tax data.

Data Sets 1404: The data sets module 1404 accesses and stores data about various aspects of the properties and locations that the buyer 130 is interested in. This may include data such as crime rates, schooling information, accessibility data, and property tax rates.

Buyer Interests and behavior: The buyer 130 interests and behavior module track the buyer's interests and behavior, such as the properties they have viewed and the actions they have taken on platform 1402. This information is used to provide personalized insights to the buyer 130.

Personalized Insights 1406: The personalized insights 1406 module generates insights for the buyer 130 based on the data sets and the buyer's interests and behavior. This may include information such as crime rates, schooling information, accessibility data, and property tax rates for the properties that the buyer 130 is interested in.

FIG. 15A˜FIG. 15B_depicts a sample code of crime score generator, according to one embodiment herein. Crime Score Generator 224 is a module designed to help real estate agents and buyers 130 make informed decisions about properties by providing them with a crime score. The crime score is generated based on various factors such as the type of crime, frequency, and severity of crimes in the neighborhood where the property is located. To implement this module, we first need to gather crime data from public sources such as police departments, crime reporting agencies, and other public databases. This data is then analyzed using machine learning algorithms to identify patterns and trends in crime rates for different neighborhoods.

Once the analysis is completed, a crime score is generated for each neighborhood based on the severity and frequency of crimes. This score can then be used by real estate agents and buyers 130 to assess the safety of a particular area and make informed decisions about buying or selling properties. The Crime Score Generator module 224 can be integrated into existing real estate platforms to provide a seamless experience for users. Users can simply enter the address of the property they are interested in, and the module will provide them with a crime score for the surrounding neighborhood. By providing real estate agents and buyers 130 with a crime score, the Crime Score Generator module 224 can help increase transparency and trust in the real estate industry. It can also help reduce the risk of fraud and misrepresentation by providing accurate and up-to-date information about the safety of a particular area. Crime rates can be an important factor to consider when buying a home, as they can affect the safety and security of the neighborhood and the overall value of the property. High crime rates can make a neighborhood feel unsafe and can deter potential buyers from considering properties in the area. This can lead to lower property values, as buyers 130 are typically willing to pay less for homes in neighborhoods with high crime rates. On the other hand, low crime rates can make a neighborhood feel more desirable and can increase the value of properties in the area.

Buyers 130 may be willing to pay a premium for homes in neighborhoods with low crime rates, as they may perceive these areas as being safer and more desirable places to live. It is important to note that crime rates can vary significantly from one neighborhood to another, and that other factors, such as location, school district, and the condition of the property, can also affect the value of a home. As such, it is important to consider a range of factors when making a home-buying decision.

The source data is obtained from:
California Crime Data: The California Department of Justice (DOJ) maintains a database of crime data for the state of California. This data includes information on crimes reported to law enforcement agencies, as well as arrests and dispositions of cases. You can access this data through the California DOJ's open data portal (https://openjustice.doj.ca.gov/data) or by contacting the DOJ directly;
Data.gov: The U.S. government's open data portal (https://www.data.gov/) provides access to a wide range of data, including crime data for the state of California. You can search for and download crime data for specific locations or regions or explore the data using interactive visualizations;
Local law enforcement agencies: Many local law enforcement agencies in California provide crime data on their websites or through open data portals. You can search for and contact these agencies to request crime data for specific locations or regions;
Private companies: There are also several private companies that offer crime data for the state of California. These companies may charge a fee for access to their data but may provide more detailed or up-to-date information than the sources mentioned above.

Once the crime data is obtained, it can be used to generate a crime score for real estate properties by analyzing the data and calculating a score based on the frequency and severity of crimes in the area. This score can be used to help real estate buyers 130 or investors 1704 assess the safety of a particular property or neighborhood.

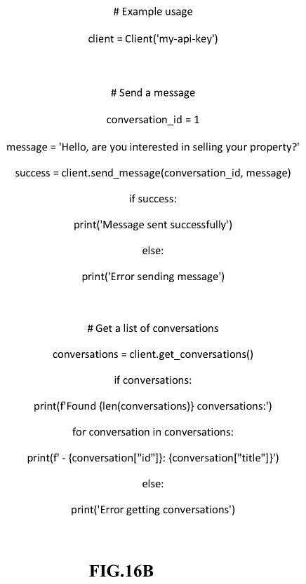

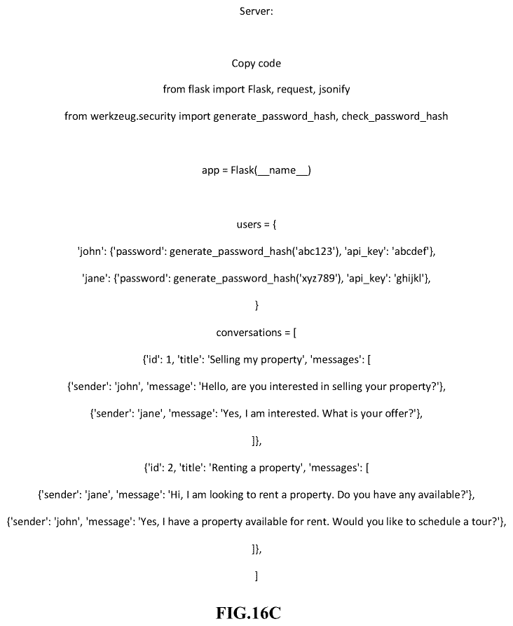

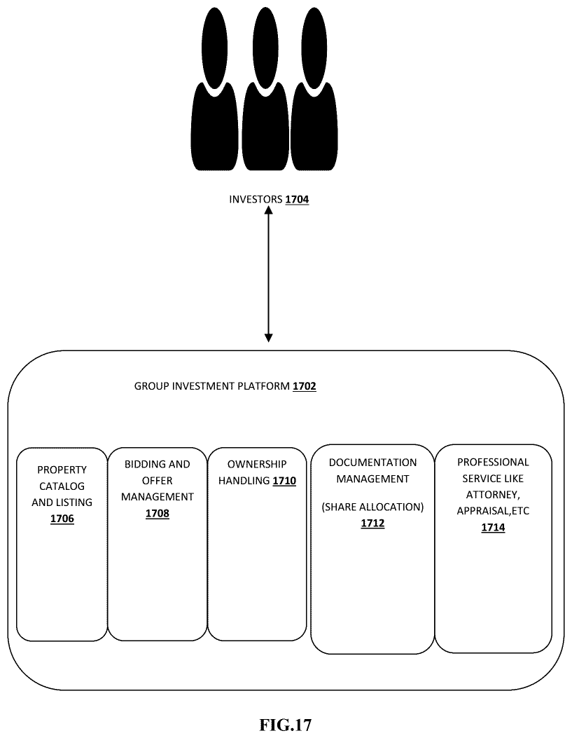

FIG. 16A˜FIG. 16C depicts a sample code of encrypted negotiation portal, according to one embodiment herein. The system of the embodiments herein enables the seller 132 and buyer 130 to communicate with each other and negotiate the price.

Client application: This is a web or mobile application that the buyer, seller 132, and service providers will use to access the negotiation portal. It may include a user interface to view and communicate with other parties, as well as tools to manage negotiations and documents.

Encryption module: This is a component of the client application that is responsible for encrypting and decrypting messages and documents transmitted through the portal. It may use a variety of encryption algorithms, such as AES or RSA, to ensure the confidentiality and integrity of the data.

Authentication module: This is a component of the client application that is responsible for verifying the identity of the user. It may use techniques such as password authentication, two-factor authentication, or biometric authentication to ensure that only authorized users can access the portal.

Communication module: This is a component of the client application that is responsible for transmitting and receiving messages and documents through the portal. It may use protocols such as HTTPS or WebSocket's to establish secure connections with the server.

Server: This is the backend infrastructure that powers the negotiation portal. It may include a server-side application to handle requests from the client application, as well as a database to store information about the negotiations and users.

Notification module: This is a component of the server that is responsible for sending notifications to users when there are updates to their negotiations or when they receive new messages. It may use techniques such as email or push notifications to alert users of these events.

Document/Chat management module: This is a component of the server that is responsible for storing and serving documents transmitted through the portal. It may include features such as version control and access control to ensure the security and integrity of the documents.

FIG. 17 depicts the group invested platform 1702, according to one embodiment herein. This diagram shows the various components of the group investment platform 1702 and how they work together to facilitate group investment in properties. The investors 1704 interact with the group investment platform 1702, which is implemented as an API server 1224. The platform provides a range of services, such as a property catalog that lists available properties 1706, a bidding and offer management system 1708, and a document generation module 1712 that issues documents to the individuals based on their percentage share. The property catalog module 1706 handles the listing and management of properties that are available for investment, including details about the property, the location, the asking price, and any relevant documents or information.

The catalog may also include features such as virtual tours, floor plans, and photos to help investors 1704 make informed decisions. The bidding and offer management module 1708 facilitates the process of submitting and accepting bids on properties, as well as managing offers and negotiations between the investors 1704 and the property owner. Finally, the document generation module 1712 is responsible for issuing documents to the individual investors 1704 based on their percentage share in the property. This may include documents such as ownership agreements, share allocation agreements, and any other relevant documentation. The group investment platform 1702 is designed to facilitate investment in properties by groups of non-related individuals. It provides a range of services to help investors 1704 find and bid on properties, as well as manage offers and negotiations with the property owner.

One key component of the platform is the property catalog, which lists available properties and provides information and resources to help investors 1704 make informed decisions. The property catalog 1706 might include features such as virtual tours, floor plans, photos, and other relevant details about the property.

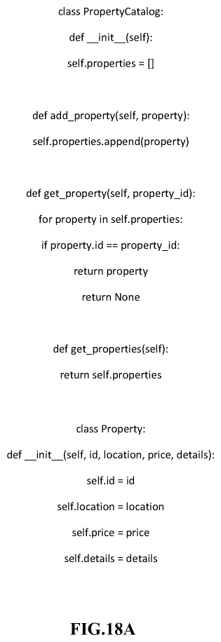

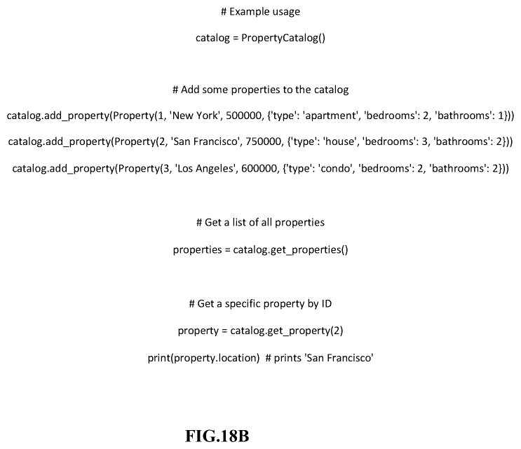

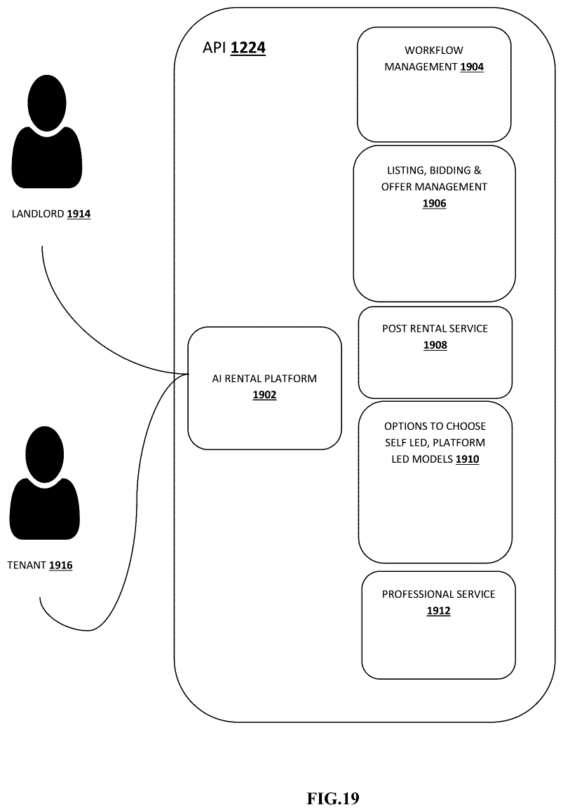

FIG. 18A˜FIG. 18B depicts the sample code of the group invested platform, according to one embodiment herein. This code defines a Property Catalog class 1706 that stores a list of Property objects, each of which represents a property that is available for investment. The Property catalog class 1706 provides methods for adding and retrieving properties, as well as a method for getting a list of all properties in the catalog. The Property class represents a single property and includes details such as the location, price, and various details about the property. The example usage code creates a new Property catalog object and adds three properties to it. It then retrieves a list of all properties and a specific property by ID and prints the location of the property.

The group investment platform 1702 might also include a bidding and offer management module 1708 to facilitate the process of submitting and accepting bids on properties. This module 1708 might include features such as a bidding interface for investors 1704 to submit their bids, a notification system to alert investors 1704 of new properties and updates to existing bids, and tools for managing negotiations. The group investment platform 1702 is designed to facilitate investment in properties by groups of non-related individuals. It provides a range of services to help investors 1704 find and bid on properties, as well as manage offers and negotiations with the property owner. One key component of the platform is the property catalog, which lists available properties and provides information and resources to help investors 1704 make informed decisions.

The property catalog 1706 might include features such as virtual tours, floor plans, photos, and other relevant details about the property. The group investment platform 1702 might also include a bidding and offer management module 1708 to facilitate the process of submitting and accepting bids on properties. This module might include features such as a bidding interface for investors 1704 to submit their bids, a notification system to alert investors 1704 of new properties and updates to existing bids, and tools for managing negotiations. The bidding and offer management module 1708 are responsible for facilitating the process of submitting and accepting bids on properties. It might include a user interface that allows investors 1704 to view available properties and submit their bids, as well as a notification system to alert investors 1704 of new properties and updates to existing bids.

FIG. 19 depicts a system architecture for AI rental platform, according to one embodiment herein. This diagram shows the various components of the AI rental platform 1902 and how they work together to facilitate property rentals. The landlord and tenant interact with the AI rental platform 1902, which is implemented as an API server 1224. The AI rental platform 1902 provides a range of workflow management services 1904, such as listing, bidding, offer management 1906, post rental services, and management 1908, to help facilitate the rental process. The workflow management module 1904 handles the various tasks and processes involved in property rentals, such as listing the property, accepting bids from potential tenants, managing offers, and providing post rental services and management. This may involve integrating with external APIs or data sources to access information about the property, the landlord, and the tenant, as well as implementing various features and functionality to facilitate the rental process. The machine learning module uses predictive modeling techniques to analyses data about the property, the landlord, and the tenant to identify patterns and trends that can be used to optimize the rental process. For example, the machine learning module might be able to predict the likelihood of a particular tenant being approved.

If Property owner is interested in selling the property, they can choose the following options to list the property in the platform 1910:
a) Self-led model;
b) Platform led model;
c) Realtor led model.

Self-led model: Sellers 132 can leverage the platform guided/recommended professional service to get started on the listing process.
a) Step 1: Intelligent Marketplace to choose from recommended professional services to list the property including inspection, photography, etc;
b) Step 2: Behavioural model to recommend Intelligent inventory of Tools for seller 132 to modify the contents like photo editing, catalo, brochures, email templates for campaigns, Open houses, Physical and Digital signage;
c) Step 3: Open house tools to promote the property using the content created by above tools and with targeted ads by the ad optimization tools;
d) Step 4: VR/AR powered property tours with customized virtual staging option on the metaverse platform where user can experience the real tour experience which could save time for busy buyers;
e) Step 5: State of the art multivariate bidding system that helps sellers 132 to extract more capital gains from their property sale. This will substitute the manual open bidding process run by realtor;
f) Step 6: Platform provides key highlights about the incoming offers in case of blind bidding and Sellers 132 will have flexibility to chat and negotiate with buyers 130;
g) Step 7: Upon acceptance of the buyer offer, the platform can guide both sellers 132 and buyers 130 to complete the documentation process and close the deal.

Platform led model: For busy sellers 132, the platform takes care of the end-to-end listing process by providing the fixed pricing structure. All the above listed services are included and managed by the company.

Realtor led model: Realtors 252 can subscribe to leverage subset of the bidding module and personalized intent retargeting service.

Platform powered Buyer Workflow: Platform collects the different signals about the customer activities and interests which powers the personalized recommendations.
a) Step 1: Buyer 130 can browse the catalogue after signup;
b) Step 2: We match buyers 130 to access different services like lending, educational videos, and training;
c) Step 3: Proprietary survey to fill out and provide the personalized recommendations and find the best property for buyers 130 based on their interest.
d) Step 4: Collect signals of user activities and browsing history;
e) Step 5: Build behavioural model and recommendation engine for buyer 130 model;
f) Step 6: Model provides the different metrics important to the buyer 130 like crime score, access score, etc;
g) Step 7: Platform facilitates communications, appointments and VR tours which help to reduce the time consumption in manual efforts.

If the buyer 130 is serious about buying the property, he can choose the following options to go through the buying process.
a) self-led model;
b) Realtor led model;
c) Platform led model.

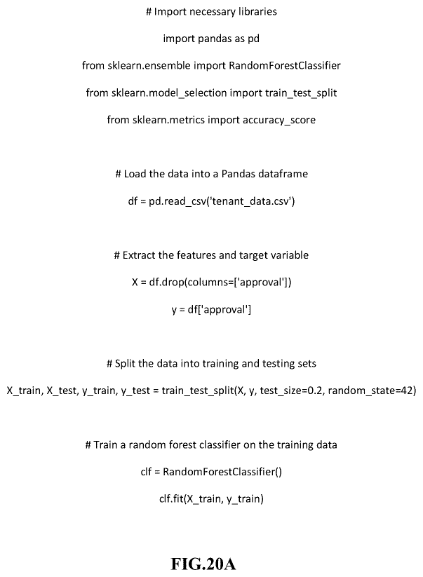

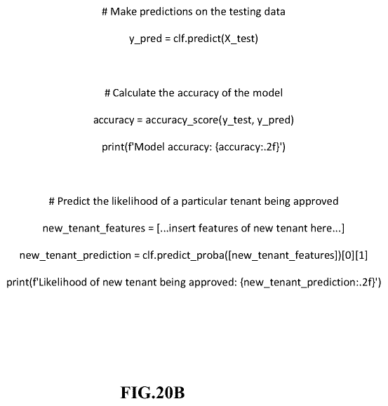

FIG. 20A˜FIG. 20B depicts the sample code of machine learning model to predict the likelihood of a particular tenant being approved, according to one embodiment herein.

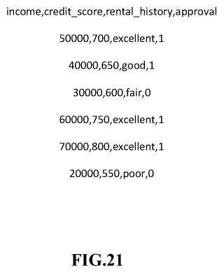

FIG. 21 depicts the sample data of machine learning model to predict the likelihood of a particular tenant being approved, according to one herein. This data contains information about six tenants, including their income, credit score, rental history, and approval status. The approval column indicates whether or not the tenant was approved (1 for approved, 0 for not approved). The code uses this data to train a machine learning model that can predict the likelihood of a tenant being approved based on their income, credit score, and rental history. This code assumes that you have a CSV file called tenant_data.csv that contains data about tenants, including a target variable called approval that indicates whether or not the tenant was approved. The code loads this data into a Pandas data frame, extracts the features and target variable, and splits the data into training and testing sets. Next, the code trains a random forest classifier on the training data and uses it to make predictions on the testing data. The accuracy of the model is then calculated using the accuracy score function from scikit-learn. Finally, the code uses the trained classifier to predict the likelihood of a particular tenant being approved by calling the method and extracting the probability of the positive class (i.e., approval).

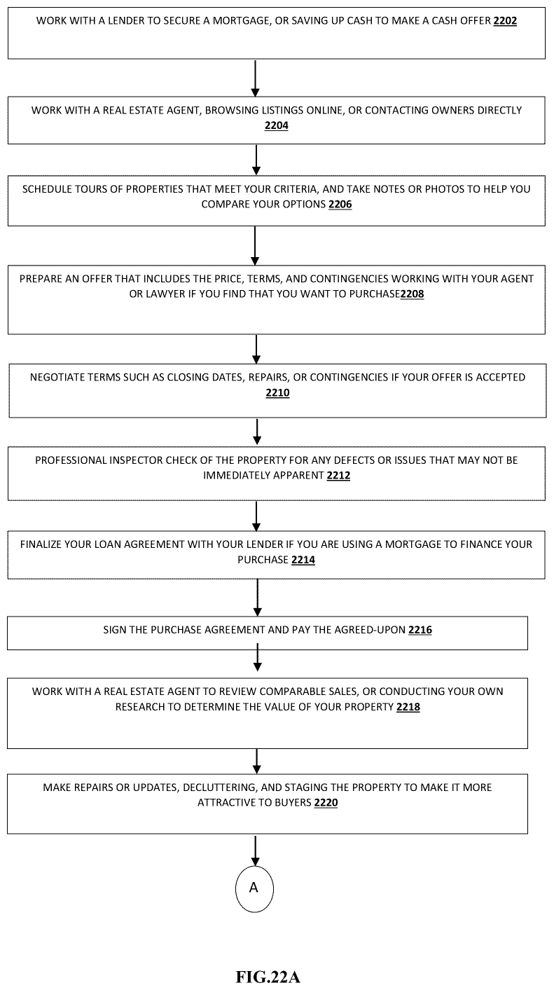

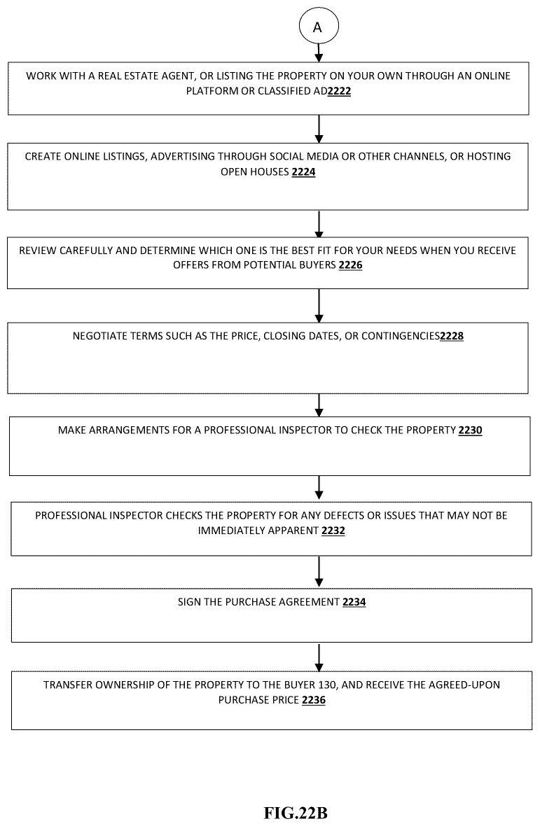

FIG. 22A˜FIG. 22B depicts a flowchart of a method of current real estate transaction, according to one embodiment herein.
a) Step 2202: working with a lender to secure a mortgage or saving up cash to make cash offer.
b) Step 2204: consideration of factors such as location, size, style, and features that are important to the buyer.
c) Step 2206: working with a real estate agent, browsing listings online, or contacting owners directly.
d) Step 2208: scheduling the tours of properties that meet buyer's criteria and take notes or photos to help the buyer compare his options.
e) Step 2210: working with his agent or lawyer to prepare an offer that includes the price, terms, and contingencies, if the buyer finds a property that he wants to purchase.
f) Step 2212: negotiating the terms such as closing dates, repairs, or contingencies.
g) Step 2214: performing the check/inspection of the property by a professional inspector for any defects or issues that may not be immediately apparent.
h) Step 2216: finalizing the loan agreement with the lender if the buyer is using a mortgage to finance your purchase.
i) Step 2218: signing the purchase agreement and paying the amount agreed-upon is paid.
j) Step 2220: working with a real estate agent to review the comparable sales or conducting your own research to determine the value of his property.
k) Step 2222: making the repairs or updates, decluttering, and staging the property to make it more attractive to buyers; and
l) Step 2224: working with a real estate agent or listing the property on his own through an online platform or classified advertisement.

Further to this, at the step 2226, online listings, advertising through social media or other channels, or hosting open houses are created. At the step 2228, review them carefully to determine which one is the best fit for your needs when you receive offers from potential buyers.

In addition, at step 2230, terms such as the price, closing dates, or contingencies are negotiated. At step 2232, arrangements are made for a professional inspector to check the property if the buyer requests a home inspection. At step 2234, the purchased agreement is signed. At step 2236, ownership of the property is transferred to the buyer, and receives the agreed-upon purchase price.

Further to the foregoing description, the present invention includes additional features, platforms and modules as follows.

### Property Listing Management:

The seller agent in the real estate industry undertakes a multitude of tasks in preparation for bringing a property to market. From coordinating with clients to staging the property, organizing inspections, and preparing marketing materials, there's a lot to manage. However, the real challenge arises when the seller agent has multiple properties in the pipeline simultaneously. Keeping track of each property's progress, deadlines, and specific requirements can quickly become overwhelming without an efficient system in place. That's where this platform comes in. It offers a centralized hub for managing all my listings, providing a comprehensive overview of each property's status and the tasks associated with it. With this platform, the seller agent can easily access and update information for each property, from uploading photos and descriptions to scheduling showings and tracking feedback. Having all this data in one place not only streamlines the seller agent's workflow but also ensures that nothing falls through the cracks amidst the hustle and bustle of managing multiple listings. Furthermore, the platform's intuitive interface allows me to prioritize tasks, set reminders, and collaborate with team members or clients, enhancing communication and efficiency throughout the listing process. Whether it's monitoring the progress of a property's marketing campaign or following up on paperwork, the seller agent can stay organized and in control every step of the way. This platform revolutionizes the way the seller agent manages his listings, providing a centralized solution that empowers him to navigate the complexities of real estate sales with case and confidence.

AI powered Task recommendation: When adding a property to the listing management system, one of the invaluable features is the ability to upload essential documents such as inspection reports or other property-related paperwork. This functionality serves as a repository for crucial information that aids in streamlining the listing process. What sets this platform apart is its integration of an in-house trained AI model. This AI model is designed to intelligently analyze the uploaded documents, extracting key details and insights to facilitate better decision-making. For instance, when an inspection report is uploaded, the AI can parse through the document, identifying any areas of concern or recommended repairs. Based on its analysis, the AI can then generate recommendations for necessary tasks or actions that may be required for the property. These recommendations could range from minor repairs and maintenance to more significant renovations or updates. By leveraging the AI's capabilities, realtors can gain valuable insights into the property's condition and proactively address any issues before listing it on the market. Moreover, the AI's recommendations are not only based on the content of the documents but also take into account historical data and industry best practices. This ensures that the suggestions provided are both accurate and relevant to the specific property and its market context. Ultimately, by harnessing the power of AI-driven document analysis, this platform empowers realtors to make informed decisions and take proactive steps to optimize their listings for success. It streamlines the process of identifying necessary tasks, saving time and resources while enhancing the overall efficiency and effectiveness of property management.

Task Planner and Tracker: The Task Planner and Tracker feature is an essential component of this platform, providing realtors with comprehensive tools to manage and monitor the tasks associated with their properties in a dynamic and organized manner.

Planning Recommended Tasks: After receiving recommendations from the AI model or manually adding tasks, realtors have the flexibility to further refine and customize the task list according to their specific needs and preferences. This customization allows realtors to tailor the task plan to address unique aspects of each property, ensuring a personalized approach to property management.

Promotion to Task Tracker: Once tasks are planned and finalized, they can be seamlessly promoted to the Task Tracker. This transition ensures that planned tasks are effectively tracked and managed throughout their lifecycle. Realtors can easily monitor the progress of tasks, track deadlines, and allocate resources as needed, all within the Task Tracker interface.

Holistic View of Tasks: The Task Tracker provides realtors with a holistic view of tasks, allowing them to gain insights into the status of tasks on specific properties or across all their listings. This bird's-eye view enables realtors to identify priorities, anticipate potential bottlenecks, and allocate resources strategically to ensure timely completion of tasks.

Different Views for Enhanced Tracking: To accommodate different preferences and workflows, the Task Tracker offers multiple viewing options, including a kanban board view. This visual representation allows realtors to organize tasks into columns based on their status (e.g., Not Started, In Progress, overdue and done/0) and easily track their progression through each stage. Realtors can drag and drop tasks between columns, update task statuses, and visualize the workflow in a clear and intuitive manner.

Property Checklists: This platform offers a personalized listing checklist feature designed to assist realtors in ensuring that all necessary tasks are completed before a property is listed on the market. This checklist serves as a comprehensive guide, outlining essential steps and requirements to streamline the listing process and maximize the property's market readiness.

Personalized Checklists: Each realtor has the flexibility to create and customize their listing checklist according to their unique preferences, workflows, and the specific requirements of their properties. This customization capability allows realtors to tailor the checklist to align with their standard practices and address any property-specific considerations.

Comprehensive Guidance: The listing checklist provides comprehensive guidance on the various tasks and actions required to prepare a property for listing. From staging and photography to documentation and marketing materials, the checklist covers a wide range of essential elements to ensure a thorough and effective listing process.

Step-by-Step Approach: The checklist follows a step-by-step approach, breaking down the listing process into manageable tasks and milestones. Realtors can easily track their progress and identify any outstanding items that require attention, ensuring that nothing is overlooked or forgotten in the rush to list the property.

Checklist Item Customization: Realtors have the ability to customize checklist items to reflect their specific needs and preferences. Whether it's adding additional tasks, modifying existing items, or categorizing tasks according to priority or urgency, realtors can tailor the checklist to suit their individual requirements and optimize their listing workflow.

Teams Collaboration: The Teams section of the platform offers a collaborative workspace where realtors can seamlessly invite and collaborate with co-realtors, vendors, and sellers to share property status updates and timelines. This feature enhances communication, coordination, and transparency among all stakeholders involved in the listing process, facilitating smoother transactions and improved client satisfaction.

Invitation Functionality: Realtors have the option to invite relevant parties, including co-realtors, vendors (such as photographers, inspectors, and contractors), and sellers, to join the team associated with a specific property. Invitations can be sent via email or through the platform, providing recipients with access to the property's dedicated team space.

Seamless Sharing of Information: Once invited, team members can seamlessly access and share property-related information, including status updates, documents, and timelines, within the dedicated team space. This centralized hub serves as a repository for collaboration, allowing all stakeholders to stay informed and engaged throughout the listing process.

Real-Time Updates: Team members can provide real-time updates on property status, progress, and tasks, ensuring that everyone is kept in the loop regarding important developments. This transparency fosters a sense of accountability and teamwork, enabling effective problem-solving and decision-making as challenges arise.

Customizable Access Levels: The platform offers customizable access levels for different team members, allowing realtors to control the level of information shared with each individual. For example, realtors may grant full access to co-realtors while restricting vendors to specific tasks or updates relevant to their role, ensuring data privacy and security.

Integrated Timeline Management: The Teams section integrates seamlessly with the platform's timeline management tools, enabling team members to coordinate schedules, deadlines, and milestones effectively. Realtors can visualize the property's timeline, track progress, and identify any potential delays or bottlenecks, facilitating proactive management and timely resolution of issues.

Communication Tools: The platform provides communication tools such as messaging and commenting functionalities within the Teams section, allowing team members to collaborate and communicate directly within the platform. This eliminates the need for separate communication channels and ensures that discussions are documented and accessible to all relevant parties.

### Prospect Management

Managing prospects effectively is a crucial aspect of a realtor's job, and it often involves juggling multiple leads while ensuring personalized communication and follow-ups. The Prospect Management feature of the platform addresses these challenges by providing realtors with robust tools to organize, track, and engage with prospects in a systematic and efficient manner.

Lead Tracking and Interest Levels: Realtors can track the interests and preferences of each prospect, capturing valuable information such as property preferences, budgetary constraints, desired locations, and any specific criteria they may have. This allows realtors to tailor their communication and offerings to better meet the needs of each individual prospect.

Communication Context History: The platform maintains a comprehensive history of communication with each prospect, including emails, phone calls, meetings, and other interactions. This contextual history provides realtors with valuable insights into previous conversations and interactions, enabling them to pick up where they left off and maintain continuity in communication.

Automated Communication and Reminders: Realtors can set up automated communication workflows to send personalized messages, such as anniversary wishes, property tax reminders, or other relevant notifications, based on predefined triggers or timelines. This helps realtors stay top-of-mind with prospects and nurture relationships over time without requiring manual follow-ups for routine tasks.

Customizable Labels and Tags: The platform allows realtors to add customized labels and tags to prospects, enabling them to categorize leads based on their preferences, interests, stage in the buying process, or any other relevant criteria. This tagging system streamlines prospect management and facilitates targeted communication strategies tailored to each group's specific needs.

Prospect Segmentation: By leveraging the customizable labels and tags, realtors can segment their prospect list into distinct categories or segments, such as first-time homebuyers, investors, or luxury property seekers. This segmentation enables realtors to tailor their marketing efforts and communication strategies to resonate with each group's unique preferences and priorities.

Prospect acquisition: The platform offers a seamless prospect acquisition process through the generation of QR codes, which can be effortlessly created and shared by realtors to attract new prospects. This innovative feature simplifies the lead generation process, particularly during open houses or marketing campaigns, by allowing realtors to capture prospect information automatically and organize it under the respective listing properties.

Self Service QR Code Generation: Realtors can generate QR codes directly within the platform, assigning each code to a specific property listing. These QR codes serve as a digital gateway for prospects to access property information and provide their contact details effortlessly.

Integration with Marketing Channels: The QR codes can be easily integrated into various marketing materials, including flyers, brochures, signage, and online advertisements. Realtors can strategically place these QR codes at open houses, property showings, or marketing events to attract prospective buyers and facilitate engagement.

Automated Prospect Collection: When a prospect scans the QR code using their smartphone or mobile device, they are directed to a landing page where they can view detailed property information and submit their contact details. The platform automatically collects and organizes this prospect information, associating it with the corresponding property listing.

Customizable Landing Pages: Realtors have the flexibility to customize the landing pages linked to the QR codes, tailoring them to showcase property highlights, photos, virtual tours, and other relevant details. This customization enhances the prospect's experience and encourages them to provide their contact information for further engagement.

Real-Time Prospect Tracking: The platform provides real-time tracking of QR code scans and prospect submissions, enabling realtors to monitor the effectiveness of their marketing efforts and identify high-potential leads promptly. This insight allows realtors to prioritize follow-up actions and nurture relationships with prospects more effectively.

Integration with Listing Properties: The prospect information collected through QR code scans is automatically organized and associated with the respective listing properties within the platform. This seamless integration ensures that realtors can access prospect data within the context of specific properties, facilitating targeted follow-up and personalized communication.

Enhanced Data Management: By automating prospect collection and organization, the platform streamlines data management processes for realtors, minimizing manual data entry and reducing the risk of errors or oversights. This efficiency enables realtors to focus their time and resources on building relationships and closing deals.

AI-generated marketing email campaign: The platform offers a powerful AI-generated marketing email campaign feature designed to streamline and enhance the prospect engagement process for realtors. Leveraging advanced AI technology, realtors can create dynamic and personalized email campaigns that resonate with prospects, driving engagement and nurturing relationships effectively.

Dynamic Template Generation: With the AI-generated marketing email campaign feature, realtors have access to a library of dynamic email templates that can be customized to suit their branding and messaging preferences. These templates are intelligently generated by the AI based on industry best practices, user preferences, and historical data analysis.

Personalized Content Recommendations: The AI analyses prospect data, including their preferences, behavior, and engagement history, to generate personalized content recommendations for each email campaign. This ensures that the content is relevant and tailored to the individual interests and needs of each prospect, increasing the likelihood of engagement.

Automated Content Generation: Realtors can rely on the AI to automatically generate email content based on the personalized recommendations and template selection. The AI dynamically populates the email with compelling text, images, and call-to-action elements, optimizing the content for maximum impact and effectiveness.

Segmentation and Targeting: Realtors can segment their prospect lists based on various criteria, such as demographics, interests, and engagement levels. The AI utilizes these segments to tailor the content and messaging of each email campaign, ensuring that it resonates with the specific preferences and needs of each audience segment.

Automated Scheduling and Delivery: The platform enables realtors to schedule and automate the delivery of their email campaigns, ensuring timely and consistent communication with prospects. Realtors can set up drip campaigns, trigger-based emails, and follow-up sequences to nurture leads and maintain engagement over time.

Performance Analytics and Insights: Realtors have access to comprehensive analytics and insights into the performance of their email campaigns. The platform tracks key metrics such as open rates, click-through rates, and conversion rates, providing real-time feedback on campaign effectiveness and informing future strategy adjustments.

Personalized Integrated messaging capability: The platform offers a personalized integrated messaging capability that enables realtors to communicate effectively with different personas using various communication channels such as SMS, email, and app notifications. This feature enhances realtors' ability to engage with prospects, clients, and team members in a timely and personalized manner, facilitating seamless communication and relationship management.

Multi-Channel Communication: Realtors have the flexibility to communicate with different personas using their preferred communication channels, whether it's SMS, email, or app notifications. This multi-channel approach ensures that messages reach recipients through their preferred medium, maximizing the chances of engagement and response.

Personalized Messaging: Realtors can personalize their messages based on the recipient's preferences, interests, and communication history. Whether it's sending a personalized property recommendation via email, a timely reminder via SMS, or an urgent task update via app notification, realtors can tailor their messages to resonate with each individual recipient.

Real-Time Alerts and Notifications: Realtors can set up personalized real-time alerts and notifications for various events and updates, such as task assignments, property inquiries, showing requests, or important deadlines. These alerts ensure that realtors stay informed and proactive, enabling them to respond promptly to critical events and opportunities.

Task Updates and Reminders: Realtors can configure personalized alerts and reminders for task updates, deadlines, and milestones associated with their listings and transactions. Whether it's scheduling a property showing, following up with a prospect, or completing paperwork, realtors can stay on top of their tasks and commitments with ease.

Integration with Task Management: The integrated messaging capability seamlessly integrates with the platform's task management tools, allowing realtors to receive task-related alerts and notifications directly within their preferred communication channels. This integration ensures that realtors can stay organized and productive, even when on the go.

Two-Way Communication: The messaging capability supports two-way communication, enabling realtors to engage in real-time conversations with prospects, clients, and team members. Whether it's answering inquiries, providing updates, or addressing concerns, realtors can maintain ongoing dialogue and build rapport with their contacts.

From the foregoing description, it will be seen that the instant invention is well adapted to attain all ends, goals and objects herein above set forth together with other advantages which are obvious and inherent to the structure.

### Advantages of the Present Invention

The present invention provides an intelligent real estate transaction system with personalized recommendations based on user preferences and intent. The system of the present invention:
provides a personalized recommendation that is intentionally based on user preferences and intent;
facilitates sellers to extract great value from their lifetime savings and minimize commissions paid to third parties;
ensures a better fit and higher quality investments in properties by prospective buyers by understanding their intent and providing targeted recommendations;
facilitates sellers to sell for more and buyers to make the right investments while minimizing the role of third parties who do not add value for the rates they charge;
provides a bidding system that offers multiple types of bidding such as auctions, first across the post and the like, and further allows for the immediate creation of documentation to meet compliance requirements around bids, integration with SMS and popular messaging systems and easier approval mechanisms for owners;
provides a customizable system for real estate transactions which can be run by realtors;
provides tools to enable and empower the seller and the buyer against the third parties;
provides a model of transaction based on mathematical logic and algorithm to make the system efficient than a manual bidding system;
facilitates transparency on the bidding system to buyers if the seller so chooses;
provides an inspection report and summarized disclosure to facilitate savings of time for both the buyer and realtor;
provides an artificial intelligence (AI) driven conversational and interactive advisor and guide for the buyer and realtor, with a predictive intent model, a math-based bidding system, and automated inspection and disclosure summaries to aid the realtor in providing high-quality services to the seller and buyer.

The foregoing description of embodiments is illustrative of various aspects/embodiments of the present invention. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Therefore, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein. Accordingly, the scope of the present invention is defined by the appended claims rather than the foregoing description of embodiments.

Throughout this detailed description, the terms “in an embodiment,” “in one embodiment,” “in some embodiments,” “in several embodiments,” “in at least one embodiment,” “in various embodiments,” and the like, are used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

The accompanying drawings that form a part hereof show, by way of illustration and not of limitation, specific embodiments in which the subject matter may be practiced. The embodiments illustrated herein are described in sufficient detail to enable those skilled in the art to practice the teachings disclosed herein. Other embodiments may be utilized and derived therefrom, such that substitutions/modifications, alterations and changes may be made without departing from the scope of the present invention disclosure. The foregoing detailed description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Accordingly, although specific embodiments have been illustrated and described herein, any arrangement to achieve the same purpose may be substituted for the specific embodiments shown. The present invention disclosure is intended to cover any and all adaptations or variations of various embodiments. Combinations of the above embodiments, and other embodiments not specifically described herein, will be apparent to those of skill in the art upon reviewing the above description.

The Abstract of the present invention disclosure is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In the foregoing detailed description, various features are grouped together in a single embodiment for the purpose of streamlining the disclosure. The method of present invention disclosure is not to be interpreted to require more features than are expressly recited in each claim. Rather, inventive subject matter may be found in less than all features of a single disclosed embodiment. Accordingly, the following claims are hereby incorporated into the detailed description, with each claim standing on its own as a separate embodiment.

1. An intelligent real estate transaction system with personalized recommendations based on user preferences and intent, comprising:
a property listing database supported by block chain mechanism and consisting essentially of information related to one or more property listings with the inclusion of properties for sale or properties for rent or properties for lease or a combination thereof with each such property enlisted in the property listing database provided with a unique and specific identifier (ID), wherein the property listing database is further configured for continuous revision and renewal, wherein the block chain mechanism enables secured and tamper-proof real estate transaction and stores the information related to the real estate transaction; a web based online transactional platform configured to facilitate collaboration among a plurality of users of the real estate transaction system to share the information and resources about a property enlisted in the property listing database, wherein the online transactional platform is further configured to facilitate location and context-based targeting to sell/rent/lease the property;
at least one user authorized and authenticated to access the real estate transaction system; one or more user modules implemented as an application programming interface (API) server and functionally coupled with the property listing database via a computer network to facilitate the authorized user of the real estate transaction system to access the property listing database via a user interface on a web page or a mobile Application on an electronic communication device, wherein the user is a buyer or a seller or a realtor or a service provider, wherein the user interface is configured to enable the user to input his preferences and intent, and incorporate a wide range of data sources to enable the intelligent real estate transaction system to understand the context of the user's input and at least one machine learning algorithm used to analyse the data input/data received from the user to generate recommendations, wherein the recommendation is based on the continuously updated and analysed property listing database to identify trends and patterns, wherein the real estate transaction system further comprises:
a property listing management platform to enable a seller's agent to access and update the real estate transaction system with information on each property enlisted by the seller on the property listing database including follow-up of the progress of each such enlisted property, follow-up of deadline for the completion of the project on each such enlisted property, follow-up of specific requirement for each such enlisted property, uploading essential documents including inspection report of enlisted properties, uploading photos relevant to each such enlisted property and tracking the feedback from the user of the real estate transaction system on each such enlisted property;
a prospect management platform configured for organized management of multiple leads and make certain of personalized communication and follow-ups, wherein the realtor is provided with a plurality of tools to systematically and efficiently organize, track and engage with multiple leads;
a prospect acquisition platform configured for seamless prospect acquisition process through the generation of quick response (QR) codes which the realtor can create and share to attract new prospects, which results in the simplification of the lead generation process by allowing realtor to automatically capture prospect information and organize the captured information under the respective listing properties;
artificial intelligence (AI) generated marketing email campaign platform configured to provide AI-generated marketing email campaign feature in order to streamline and enhance the prospect engagement process for the realtor, wherein the realtor is enabled to create dynamic and personalized email campaigns that resonate with prospects by leveraging AI technology, which in turn drives engagement and nurtures effective relationship;
a personalized integrated messaging capability platform to offer a personalized integrated messaging capability which enables the realtor to communicate effectively with different personas using various communication channels such as SMS, email, and app notifications, which enhances the realtor's ability to engage with prospects, clients and team members in a timely and personalized manner to facilitate seamless communication and relationship management, wherein the various platforms, portals and modules of the intelligent real estate transaction system including the one or more user modules are configured to display the information relating to the current status of buyer driven real estate transaction events via the user interface on a web page or a mobile Application on an electronic communication device, wherein the AI based processing is functional with the property listing database and the at least one user module to process and analyse the inputs received and to further process and analyse the communications via the computer network between the at least one user module and the property listing database to generate personalized recommendations to the user.

2. The system as claimed in claim 1, wherein the one or more user module is selected from the group consisting of an artificial intelligence (AI) realty advisor, a set of tools and resources, a matching module, a machine learning (ML) based crawler module, a intent prediction module, a crime score generator module, a bidding module, a property value optimization module, a smart contract management module, a real estate metaverse module, a customer-generated content module, a proactive customer engagement module, a collaborative property listing sharing module, a real estate value prediction module, a seller/buyer matching engine, a module with incorporation of a wide range of data sources and features, a buyer insights platform, a seller insights platform, a AI realty rental platform, a collaborative filtering-based recommendation module, a group investment platform and an encrypted negotiation portal, wherein the web based online transactional platform is configured to facilitate communication between the seller and the buyer over the computer network.

3. The system as claimed in claim 1, wherein the property listing management platform enables the seller's agent to prioritize his tasks;
set reminders on the ongoing projects;
collaborate with his team members and/or the clients; and
enhance the communication and efficiency throughout the listing process.

4. The system as claimed in claim 1, wherein the property listing management platform comprises:
an integrated in-house artificial intelligence (AI) module configured:
to analyse the uploaded documents including inspection reports to extract key information and insights in order to facilitate improved decision making; and
to generate recommendations on necessary tasks to be performed with respect to the specific enlisted property and the relevant market context, based on the extracted key information and insights in consideration with the historical data and the current industry best practices, wherein the property listing management platform allows the realtor to make informed decisions and consider practical steps to optimize his listings on the property listing database, enhances the efficiency and effectiveness of the property management by the realtor and saves the time and resources;
a task planner and tracker platform configured to enable the realtor with comprehensive tools to make him actively manage and observe the tasks associated with his property in an organized way;
a property checklist platform comprising a plurality of essential steps and requirements to enable a realtor to make certain of the completion of all the necessary tasks related to a property before getting enlisted on the property listing database, wherein the property checklist platform facilitates the realtor with streamlined listing process of the property and enhanced market readiness; and
a team collaboration platform to enable a realtor to invite and collaborate with other co-realtors, vendors and sellers to share property status updates and the timelines which in turn facilitates smooth transaction with improved client satisfaction by enhanced communication and coordination with transparency among all the stake holders of the listing process, wherein the team collaboration platform comprises:
an invitation functionality module to enable a realtor with an option to invite relevant parties, including co-realtors, vendors/service providers including photographers, inspectors, and contractors, and sellers, to join the team associated with a specific property, wherein the invitation from the realtor sent through an email communication or through the team collaboration platform to facilitate the recipients of the communication from the realtor with access to the property's dedicated team space;
an information sharing module to enable the team members with seamless access and sharing of the property-related information, including status updates, documents, and timelines, within the team space, which in turn serves as a repository for collaboration among the stakeholders with an access to the information and engagement throughout the listing process of the property in the property listing database;
a real time update module to enable the team members to provide real-time updates on property status, progress, and tasks in order to make certain that every member of the team associated with a specific property is informed about the developments related to the specific property including progress and changes, which promotes a sense of accountability and teamwork to enable effective problem-solving and decision-making at the time of risks/challenges;
a customizable access module to enable the realtor to control the level of information shared with different team members;
an integrated timeline management module to enable each team member to make effective coordination of schedules, deadlines and milestones, and to provide the realtor with visualization of the property's timeline, track progress, and identification of any possible delays including hold-ups, in order to facilitate proactive management and timely resolution of the issues; and
a communication tools module to facilitate each team member with messaging and commenting options in order to enable each team member for collaboration and direct communication within the team collaboration platform which excludes the need for separate communication channels and in turn makes certain of the documentation of the discussions/communications and accession to the documented discussion/communication by the relevant party.

5. The system as claimed in claim 1, wherein the prospect management platform comprises:
a lead tracking and interest level platform configured to track the interests and preferences of each prospect by capturing valuable information including property preferences, budgetary constraints, desired locations, and any specific criteria, wherein the realtor is allowed to tailor the communications of an individual prospect and make the offer that matches with the needs of the individual prospect;
a communication context history platform configured to maintain a comprehensive history of communication with each prospect including emails, phone calls, meetings, and other interactions in order to provide the realtor with valuable insights into previous conversations and interactions to further enable the realtor to pick up where he has left off and maintain the continuity in communication;
an automated communication and reminder platform to enable the realtor to set up automated communication workflows in order to send personalized messages, such as anniversary wishes, property tax reminders, or other relevant notifications, based on predefined triggers and/or timelines, which in turn facilitates the realtor to prioritize the prospects of his clients and nurture relationships over time without requiring manual follow-ups for routine tasks;
a customizable tables and tags platform to enable the realtor to add customized labels and tags to the prospects in order to enable him to categorize the leads based on the preferences, interests, stage in the buying process, or any other relevant criteria of the prospects which results in the streamlined prospect management and further facilitates targeted communication strategies tailored to the specific needs of each group; and
a prospect segmentation platform to enable the realtor to leverage the customizable labels and tags for the segment wise division of his prospects list, such as first-time homebuyers, investors, or luxury property seekers which in turn enables the realtor to tailor his marketing efforts and communication strategies to resonate with each group's unique preferences and priorities.

6. The system as claimed in claim 1, wherein the prospect acquisition platform comprises:
a self-service QR code generation platform to enable the realtor to generate the QR code within the prospect acquisition platform and assign each such generated QR code to a specific property listing, wherein each such generated QR code configured to function as a digital gateway for the prospects to access the information related to the specific property listing and share their contact details with the realtor;
a QR code integration platform facilitated to integrate the QR codes generated by the realtor with various marketing channels including flyers, brochures, signage, and online advertisements, wherein the realtor is enabled to strategically place these generated QR codes at open houses, property showings, or marketing events to attract prospective buyers and facilitate engagement;
an automated prospect collection platform enabled to direct a prospect to a landing page after the scanning of the QR code with their mobile communication device including a smart phone, wherein the prospect is enabled to access the detailed information on the property and share their contact information which facilitates the automatic collection and organization of the contact information of the prospects, and associates the collected information with the corresponding property listing;
a customizable landing pages platform to provide the realtor with the flexibility to customize the landing pages linked to the QR codes, tailoring the realtor to showcase property highlights, photos, virtual tours, and other relevant details, which enhances the prospect's experience and encourages the prospects share their contact information for further engagement, wherein the contact information of the prospects are organized and associated with the corresponding property listing;
a real-time prospect tracking platform to provide the real-time tracking of QR code scans and prospect submissions, which enables the realtor to monitor the effectiveness of his marketing efforts and identify high-potential leads, the real-time tracking of QR code scans and prospect submissions further allows the realtor to prioritize the follow-up actions and nurture effective relationships with prospects;
an integration with listing properties platform enables the automatic organization and association of the prospect information collected through the QR code scans with the respective listing properties within the prospect acquisition platform to make certain that the realtor is enabled to access the prospect data within the context of specific properties, which facilitates targeted follow-up and personalized communication; and
an enhanced data management platform to enable the enhanced Data management by automating the prospect collection and organization to streamline the data management processes for the realtor, which results in the minimization of the manual data entry and reduces the risk of errors or oversights, which further enables the realtor to focus his time and resources on building relationships and closing the deals.

7. The system as claimed in claim 1, wherein the AI generated marketing email campaign platform comprises:
a dynamic template generation platform which allows the realtor to access a library of customizable AI generated dynamic email templates which matches with his branding and messaging preferences, wherein the generation of such dynamic temples is based on industry best practices, user preferences, and historical data analysis;
a personalized content recommendations platform, wherein the AI is enabled to analyse the prospect data including preferences, behaviour, and engagement history to generate personalized content recommendations for each email campaign, which makes certain that the content is relevant and tailored to the individual interests and needs of each prospect in order to increase the likelihood of engagement;
an automated content generation platform to enable the realtor to leverage the AI for automatic generation of email content based on the personalized recommendations and template selection, wherein the AI is configured to dynamically populate the email with compelling text, images, and call-to-action elements in order to optimize the content for maximum impact and effectiveness;
a segmentation and targeting platform to enable the realtor to enable the realtor to leverage the AI for the segment wise division of his prospects based on various criteria, such as demographics, interests, and engagement levels, wherein the AI utilizes these segments to tailor the content and messaging of each email campaign, and makes certain that the email campaign resonates with the specific preferences and needs of each audience segment;
an automated scheduling and delivery platform to enable the realtor to schedule and automate the delivery of his email campaigns, to make certain the timely and consistent communication with prospects, wherein the realtor is enabled to set up drip campaigns, trigger-based emails, and follow-up sequences to nurture leads and maintain the engagement over time; and
a performance analytics and insights platform to enable the realtor to have access to comprehensive analytics and insights into the performance of their email campaigns, wherein the performance analytics and insights platform tracks key metrics such as open rates, click-through rates, and conversion rates, which provides real-time feedback on campaign effectiveness and informing future strategy adjustments for the realtor.

8. The system as claimed in claim 1, wherein the personalized integrated messaging capability platform comprises:
a multi-channel communication platform to enable the realtor with the flexibility to communicate with different persons using their preferred communication channels, such as SMS, email, or app notifications, which makes certain that messages reach recipients through their preferred medium to maximize the chances of engagement and response;
a personalized messaging platform to enable the realtor to personalize his message based on the recipient's preferences, interests, and communication history in order to further enable the realtor to tailor his message to resonate with each individual recipient;
a real-time alerts and notifications platform wherein the realtor is enabled to set up personalized real-time alerts and notifications for various events and updates, such as task assignments, property inquiries, showing requests, or important deadlines which makes certain that the realtor stays informed and proactive, which enables the prompt response of the realtor to critical events and opportunities;
a task updates and reminders platform to enable the realtor to configure personalized alerts and reminders for task updates, deadlines, and milestones associated with his listings and transactions, which enables the realtor to stay on top of his tasks and commitments with ease;
an integration with task management platform wherein the seamless messaging is integrated with the integrated messaging capability seamlessly integrates with the task management tools of the personalized integrated messaging capability platform, which allows the realtor to receive task-related alerts and notifications directly within his preferred communication channels in order to make certain that the realtor stays organized and productive; and
a two-way communication platform wherein the messaging capability supports two-way communication to enable the realtor to engage in real-time conversations with prospects, clients, and team members, wherein the realtor maintains ongoing dialogue and builds rapport with his contacts.

9. The system as claimed in claim 1, wherein the seller is enabled to modify the property listing database by adding, removing, or modifying the property enlisted on the property listing database using the seller insights platform.

10. The system as claimed in claim 1, wherein the buyer is enabled to query the property enlisted on the property listing database with one or more inputs in order to identify one or more chosen property listings in the property database.

11. The system as claimed in claim 1, wherein each realtor of the system is enabled with a plurality of valuable insights and recommendations for his customers/buyers/clients using the AI realty advisor, the AI realty advisor further configured to:
a) utilize the conversational AI to facilitate the realtors to prioritize their customers and further configured to provide insights into their properties including houses, inspection reports, and likely trends in their values;
b) analyse a plurality of data sources to provide personalized insights and recommendations to the realtors in order to facilitate the realtors to better understand their customer/client base and provide more relevant and useful information to their customers/client; and
c) facilitate the realtors with property valuations performed using ML algorithms to predict the likely value of a property based on the plurality of various factors consequently enhancing the credibility of realtors and improving their ability to meet customer/client needs and preferences.

12. The system as claimed in claim 2, wherein the matching module is configured to compute the scores of the seller and buyer to build an algorithmic model to map the potential buyers and sellers, wherein the potential buyer and seller are provided with a score on their fit with each other by leveraging a plurality of attributes for the buyer and seller.

13. The system as claimed in claim 2, wherein the ML based crawler module configured to utilize at least one learning algorithm from a plurality of algorithms to automatically crawl through and check the inspection reports and other relevant documents about a property that a prospective buyer is bidding on and automatically generate key insights and issues about the property prospective buyer is bidding, wherein the crawler module:
a) provides the buyer with a comprehensive analysis of the property he is interested in, highlighting any potential issues that may need to be addressed before the sale can be finalized thereby saving time and money for the prospective buyer;
b) provides the seller with the identification of potential issues with his property before it is listed on the market to facilitate the prospective buyer to fix/address any issues before the potential buyer sees the property thereby increasing the likelihood of a successful sale; and
c) facilitate the realtor to streamline his workflow, make more informed decisions and provide a better experience to his clients.

14. The system as claimed in claim 2, wherein the intent prediction module is configured to receive buyer's data and real estate data to make predictions about the buyer's intent to buy or rent a property, and to output the predicted intent as a probability or classification, wherein:
a) activity of the buyer is collected from the interactions of the buyer with the web based online transactional platform sent to the intent platform application programming interface (API) server;
b) intent platform API server processes the activity data of the buyer and transmits it to the behavioural model that uses a set of machine learning (ML) techniques to build a model of the buyer's buying intent;
c) personalized offers based on the predicted intent are generated that includes the needs and preferences of the buyer; and
d) generated personalized offers sent to the buyer via the API server for review and to facilitate the buyer to generate response to the review.

15. The system as claimed in claim 2, wherein the crime score generator module provides the seller and the buyer buyers with valuable insights into the safety and security of different neighbourhoods of the property in which the buyer is interested in by integrating both public and private data sources to generate sub-geographic crime scores in order to facilitate the user to make informed decisions about where to buy or sell properties, the crime score generator module further configured to update in real time, the generated crime scores to facilitate the user to access the most up to date information about the property.

16. The system as claimed in claim 2, wherein the bidding module is a dynamic multivariate bidding system implemented as an API server and configured to function as a digital e-auction platform to meet the compliance requirements of each State of the United States of America (US) and to allow the sellers to list their properties in an open bidding platform, wherein the bidding module:
a) engages and informs the bidders and buyers with real time information based on their engagement with the digital e-auction platform;
b) uses at least one of a plurality of machine learning techniques to optimize the value of the property for sale and further maps the seller to specific bidding systems that are designed to maximize the value of the property;
c) comprises a plurality of such bidding systems with each such bidding system tailored to meet the specific needs and goals of the seller and configured to use different strategies and techniques to optimize the value of the property.

17. The system as claimed in claim 2, wherein the property value optimization module is configured to use at least one ML technique to analyse a plurality of factors influencing the value of the property and to use the performed analysis to identify strategies and techniques to optimize the value of the property.

18. The system as claimed in claim 2, wherein the smart contract management module is configured to streamline the real estate transaction using the blockchain network to facilitate self-executing contracts with the terms of the agreement between the buyer and the seller wherein the self-executing contracts directly written into code, and to further automate and manage the entire transaction process, from property listings to closing, with transparency and security.

19. The system as claimed in claim 2, wherein the real estate metaverse module provides a virtual reality (VR) platform to generate one or more digital representations of the physical real estate world for the buyer and seller to explore properties and neighbourhoods, wherein the real estate metaverse module utilizes advanced augmented reality (AR)/virtual reality (VR) technology to create and provide immersive and interactive experiences to the user to improve the overall user experience and engagement, wherein the VR platform is configured to be accessed through a VR headset, a mobile device, or a computer in order to allow the user to explore the property he is interested in, from anywhere in the world from the comfort of his own home.

20. The system as claimed in claim 2, wherein the customer-generated content module is configured to support a user to generate and share content about his real estate experience, wherein the customer-generated content is sued by the system to improve overall user experience and to provide social proof to other potential buyers and sellers, wherein the customer-generated content constructs the trust and credibility with potential buyers and sellers to facilitate them to value the opinions and experiences of their peers.

21. The system as claimed in claim 2, wherein the proactive customer engagement module enables the lifetime management of the customers/clients of the realtors based on personalized insights on the property they bought.

22. The system as claimed in claim 2, wherein the collaborative property listing sharing module facilitates the real estate agents and brokers to share and collaborate on property listings in the web based online transactional platform.

23. The system as claimed in claim 2, wherein the real estate value prediction module facilitates the buyers and sellers to make informed decisions about the property transactions based on a plurality of factors.

24. The intelligent real estate transaction system as claimed in claim 2, wherein the seller/buyer matching engine facilitates the matching of sellers of real estate properties with potential buyers and further brings together sellers and buyers interested in the same type of properties.

25. The intelligent real estate transaction system as claimed in claim 2, wherein the module with incorporation of a wide range of data sources and features is configured to accurately predict the behaviour of a plurality of users interested in the same type of properties.

26. The intelligent real estate transaction system as claimed in claim 2, wherein the buyer insights platform implemented as an API server facilitates the overlaying of a range of data on the interests and behaviour of the buyer to provide personalized insights to the buyer about the properties he is interested in and further enables the buyer to interact thereof.

27. The intelligent real estate transaction system as claimed in claim 2, wherein the encrypted negotiation portal enables the seller and the buyer to communicate with each other and negotiate the price.

28. The intelligent real estate transaction system as claimed in claim 2, wherein the collaborative filtering-based recommendation module enables the user to create a matrix of property ratings and to recommend the properties selected from the matrix to the user based on the ratings of the user's nearest neighbours.

29. The intelligent real estate transaction system as claimed in claim 2, wherein the group investment platform is adapted to facilitate group investment in one or more properties listed in the property listings of the property database, wherein a group of investors interact with the group investment platform implemented as an API server, wherein the group investment platform includes a property catalogue module, a bidding and offer management module, and a document generation module.

30. The intelligent real estate transaction system as claimed in claim 29, wherein the property catalogue module is configured to provide the group of investors with:
a) the listing and management of properties available for group investment;
b) one or more details about the available property that includes the location, the asking price, and relevant documents and information; and
c) a plurality of features that include virtual tours, floor plans, and photos to facilitate the group investors to make informed decisions.

31. The intelligent real estate transaction system as claimed in claim 29, wherein the bidding and offer management module is configured to:
a) facilitate the process of submitting and accepting bids on properties from the group investors; and
b) managing offers and negotiations between the group investors and the property owner, wherein the bidding and offer management module is further configured to
facilitate the process of submission and acceptance of bids;
allow the investors via a user interface to view available properties and submit their bids;
notify and alert the investors of new properties; and
update the existing bids.

32. The intelligent real estate transaction system as claimed in claim 29, wherein the document generation module is configured to issue a plurality of documents to the individual investors in the group based on their percentage share in the property that includes ownership agreements, share allocation agreements, and other relevant documentation.

33. The intelligent real estate transaction system as claimed in claim 2, wherein the system architecture of the AI rental platform implemented as an API server includes:
a) interaction of the landlord and the tenant with the AI rental platform; and
b) workflow management module to provide a plurality of work flow management services that are involved in property rentals.

34. The intelligent real estate transaction system as claimed in claim 33, wherein the plurality of work flow management services include listing the property rentals, accepting bids from potential tenants, managing offers, and providing post rental services and management, wherein the ML module used in the AI rental platform is configured to use predictive modelling techniques to analyse data about the property rental, the landlord, and the tenant to identify patterns and trends that can be used to optimize the rental process.

35. The intelligent real estate transaction system as claimed in claim 34, wherein the option chosen by a property owner to list the property in the AI rental platform is selected from the group consisting of a self-led model, a platform led model and a realtor led model.

36. The intelligent real estate transaction system as claimed in claim 34, wherein the option chosen by a buyer interested in buying the property in the AI rental platform is selected from the group consisting of a self-led model, a platform led model and a realtor led model.

37. The intelligent real estate transaction system as claimed in claim 36, wherein the self-led model of listing the property facilitates a seller to leverage the AI rental platform guided/recommended professional service that includes
a) intelligent marketplace to list the property including inspection and photography;
b) behavioural model to recommend Intelligent inventory of tools to modify the contents of the photographs using photo editing, modify the contents of catalogues, brochures, email templates, physical and digital signage, and open houses, wherein the modified content of the open houses used to promote the listed property using one or more advertisement optimization tools;
c) property tours powered by AR/VR with customized virtual staging option on the metaverse platform where a user experiences an almost “real” tour experience that saves time for busy buyers;
d) state of the art multivariate bidding system to facilitate sellers to extract increased capital gains from their property sale that substitutes the manual open bidding process run by the realtor;
e) key highlights provided about the incoming offers in case of blind bidding and to facilitate the sellers with flexibility to chat and negotiate with the buyers; and
f) sellers and buyers guided to complete the documentation process and close the deal upon acceptance of the offer by the buyer.

38. The intelligent real estate transaction system as claimed in claim 35, wherein the platform led model chosen by a property owner to list the property in the AI rental platform includes the AI rental platform executing the complete end-to-end listing process by providing the fixed pricing structure.

39. The intelligent real estate transaction system as claimed in claim 35, wherein the realtor led model chosen by a property owner to list the property in the AI rental platform includes one or more realtors to subscribe to the AI platform to leverage subset of the bidding module and personalized intent retargeting service.

40. The intelligent real estate transaction system as claimed in claim 36, wherein the platform led model of buying the property facilitates a buyer to leverage the AI rental platform guided/recommended professional service that includes:
a) enablement of a buyer to browse the catalogues of property/property listings after subscription to the AI rental platform and signing up;
b) accession of the buyer to one or more services including lending, educational videos, and training, after the matching up of the buyer;
c) a proprietary survey to be filled out by the buyer to receive the personalized recommendations and to find the best property based on his interest;
d) collection of signals of user activities and browsing history;
e) construction of one behavioural model of the buyer and further construction of a recommendation engine for the behavioural model of the buyer;
f) a plurality of essential metrics provided to the buyer in accordance with the behavioural model; and
g) facilitation of communications, appointments and VR tours to the buyer to reduce the time consumption in manual efforts.
